(19) United States
(12) Patent Application Publication
(10) Pub. No.: US 2014/0007154 A1
(43) Pub. Date: Jan. 2, 2014

(54) SYSTEMS AND METHODS FOR PROVIDING INDIVIDUALIZED CONTROL OF MEDIA ASSETS

(71) Applicants: Edwin A. Seibold, Mission Viejo, CA (US); Christine Angelli, Santa Monica, CA (US); Cynthia A. Halstead, Palo Alto, CA (US); Walter R. Klappert, Los Angeles, CA (US); William J. Korbecki, Crystal Lake, IL (US)

(72) Inventors: Edwin A. Seibold, Mission Viejo, CA (US); Christine Angelli, Santa Monica, CA (US); Cynthia A. Halstead, Palo Alto, CA (US); Walter R. Klappert, Los Angeles, CA (US); William J. Korbecki, Crystal Lake, IL (US)

(73) Assignee: United Video Properties, Inc., Santa Clara, CA (US)

(21) Appl. No.: 13/537,992

(22) Filed: Jun. 29, 2012

(51) Int. Cl. H04N 21/258

(52) U.S. Cl. 725/25

(57) ABSTRACT

Systems and methods for providing individualized content controls of media assets are provided. In certain embodiments, a processing device delivers a first media asset to a first user using a first presentation device of an electronic media device. The processing device receives a signal indicative of a second user in proximity to the electronic media device, and, in response, accesses a profile associated with the second user. While continuing to deliver the first media asset, the processing device delivers a second media asset to the second user that satisfies the media access permissions of the second user profile using a second presentation device of the electronic media device. The second media asset may be a modified version of the first media asset.

### BACKGROUND OF THE INVENTION

Modern day consumers are confronted with numerous entertainment options and a large amount of available media content. Thousands of videos, songs, and articles are available to users through the Internet, television, and other gateways to media content. In such an environment, some content may not be suitable for all users.

In a traditional parental control system, content is controlled by restricting certain types of content at a specific device or for a specific user. For example, restriction or filter settings at a media player, such as a television or computer, may prohibit certain types of content from being displayed to any user by the media player. Alternatively, content settings may be tailored to a specific user logged into the media device. These and other traditional systems are ineffective at targeting and tailoring content to multiple users simultaneously who may have different content permissions or restrictions.

### SUMMARY OF THE INVENTION

In view of the foregoing, it would be desirable to provide systems and methods for providing individualized media content to multiple users at a media device. In particular, it would be desirable to provide a media device configured to present media content by identifying users in proximity to the media device, retrieving media content access permissions for the identified users, and simultaneously presenting the media content to each user in a form that substantially satisfies the media content access permissions of each user.

Accordingly, systems and methods for providing individualized content controls of media assets are provided. In certain embodiments, a processing device delivers a media asset to a first user using a first presentation device of an electronic media device. The processing device receives a signal, from a user identification device, indicative of a second user associated with a second presentation device of the electronic media device. The processing device accesses, from a memory, a profile associated with the second user indicated by the received signal. In certain approaches, the second user profile includes media access permissions. In certain approaches, the profile is stored on a remote server, and the processing device accesses the remote server. The processing device identifies the media asset being delivered to the first user, receives a signal representative of an attribute of the identified asset, and compares the attribute of the identified asset with the media access permission of the second user. The media device then delivers an access-aligned version of the identified asset to the second user using a second presentation device of the electronic media device while delivering the media asset to the first user using the first presentation device of the electronic media device. The access-aligned version of the media asset satisfies the media access permission of the second user profile and differs from the media asset in at least one of visual content and audio content. In certain approaches, the first presentation device and second presentation device are integral to the electronic media device.

In certain embodiments, the processing device receives a signal, from the user identification device, indicative of the first user associated with the first presentation device of the electronic media device. The processing device accesses, from the memory, a profile associated with the first user, wherein, the first user profile includes media access permissions. In certain approaches, the profile is stored on a remote server, and the processing device accesses the remote server. The processing device delivers the media asset in a form that satisfies the media access permissions of the first user profile.

In certain embodiments, the processing device applies biometric identification techniques to identify a user. Additionally or alternatively, the processing device may obtain an image of a user. Additionally or alternatively, the processing device may determine a position of a user. In certain approaches, the processing device identifies a user by receiving a radio frequency signal from a radio frequency beacon associated with the user.

In certain embodiments, the processing device accesses an electronic personal identification device associated with a user. The electronic personal identification device may include a memory, which stores a user profile associated with the second user. For example, the processing device may access a receptacle of the electronic personal identification device in a receptacle of the electronic media device. In some approaches, the personal identification device is a personal listening device.

In some embodiments, the processing delivers the first media asset with a first image content to a first display and a second media asset with a second image content different from the first image content to a second display different from the first display. Alternatively or additionally, the processing device may deliver the first media asset via a first audio output and the second media asset different from the first media asset to a second audio output different from the first audio output.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 shows an illustrative interactive media guidance application display screen in accordance with some embodiments of the present disclosure;

FIG. 2 shows another illustrative interactive media guidance application display screen in accordance with some embodiments of the present disclosure;

FIG. 3 illustrates an example of a user equipment device in accordance with some embodiments of the present disclosure;

FIG. 4 shows an illustrative multi-view display screen in accordance with some embodiments of the present disclosure;

FIG. 5 is a block diagram of an illustrative audio device for presenting different audio media content to different users in accordance with some embodiments of the present disclosure;

FIG. 6 illustrates an example of a cross-platform interactive media system in accordance with some embodiments of the present disclosure;

FIG. 7 shows an illustrative detection configuration menu display screen in accordance with some embodiments of the present disclosure;

FIG. 8 shows an illustrative media access permissions configuration menu display screen in accordance with some embodiments of the present disclosure;

FIG. 9 is a flow diagram of a process for providing individualized content control of media assets in accordance with some embodiments of the present disclosure; and

FIG. 10 illustrates a user profile stored as a file in Extensible Markup Language (XML) in accordance with some embodiments of the present disclosure.

### DETAILED DESCRIPTION OF THE VARIOUS EMBODIMENTS

The systems and methods disclosed herein my be applied to provide individualized control of media content. In particular, the systems and methods described herein detect users present in a region near a media presentation device, such as a television or other display, and provide synchronized content to each user, which satisfies the access permissions for each user. Users may have individual profiles, which provide media content restrictions and are accessed by a media presentation device. For example, the systems and methods may be used to implement parental controls by simultaneously providing different content to different users, such as a standard version of a movie and an edited version of a movie. The restrictions may be carried out by detecting and identifying users, for example, through detection devices such as cameras, microphones, radio-frequency identification, facial detection, retinal readers, fingerprint readers, or other detection and identification means. The media may be presented on separate presentation devices, or may be presented from a single device using different angles of viewing and hearing, special glasses, earphones or other means. For illustrative purposes, this disclosure will often discuss exemplary embodiments of these systems and methods as applied in media guidance applications, but it will be understood that these illustrative examples do not limit the range of applications which may be improved by the use of the systems and methods disclosed herein.

The amount of content available to users in any given content delivery system can be substantial. Consequently, many users desire a form of media guidance through an interface that allows users to efficiently navigate content selections and easily identify content that they may desire or may not desire for themselves or other users, such as their children. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. For example, the multiple screens may be used to provide individualized content simultaneously to different users. In some embodiments, the user equipment device may have a front facing camera and/or a rear facing camera. The cameras may be used to detect and/or identify one or more users near the user equipment device. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a website), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

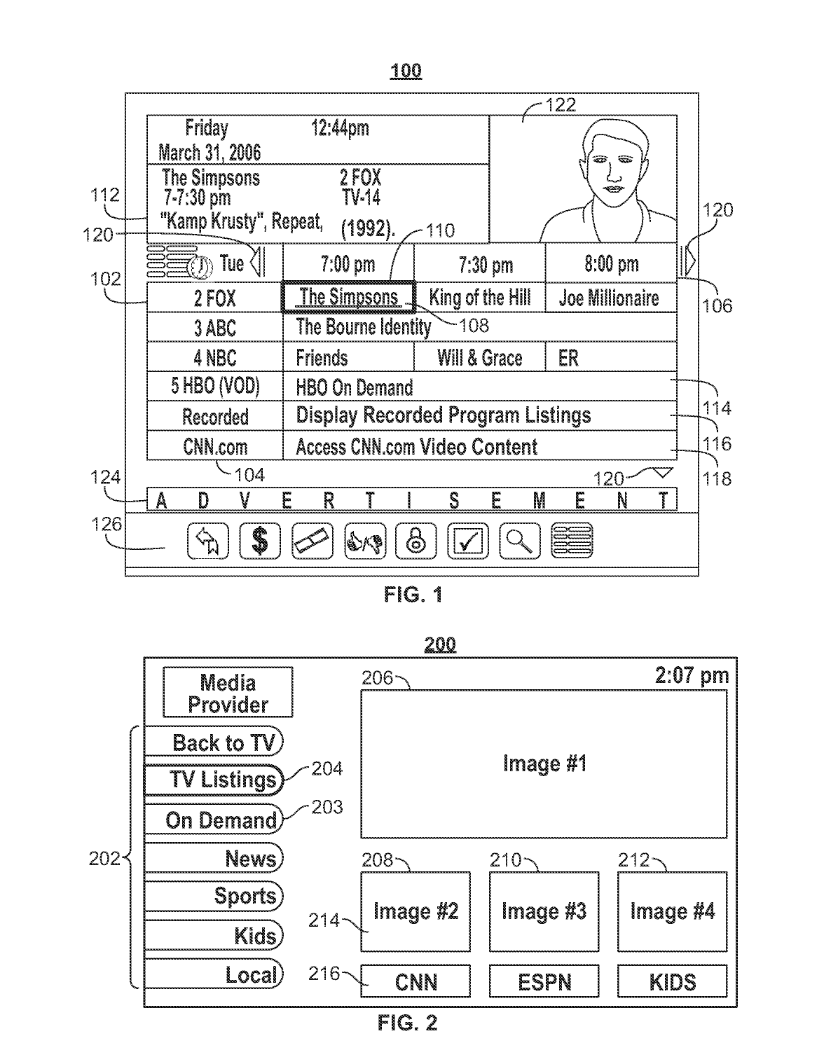

FIGS. 1-2 show illustrative display screens that may be used to provide media guidance data. The display screens shown in FIGS. 1-2 and 7-8 may be implemented on any suitable user equipment device or platform. While the displays of FIGS. 1-2 and 7-8 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

Additionally or alternatively to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g., FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

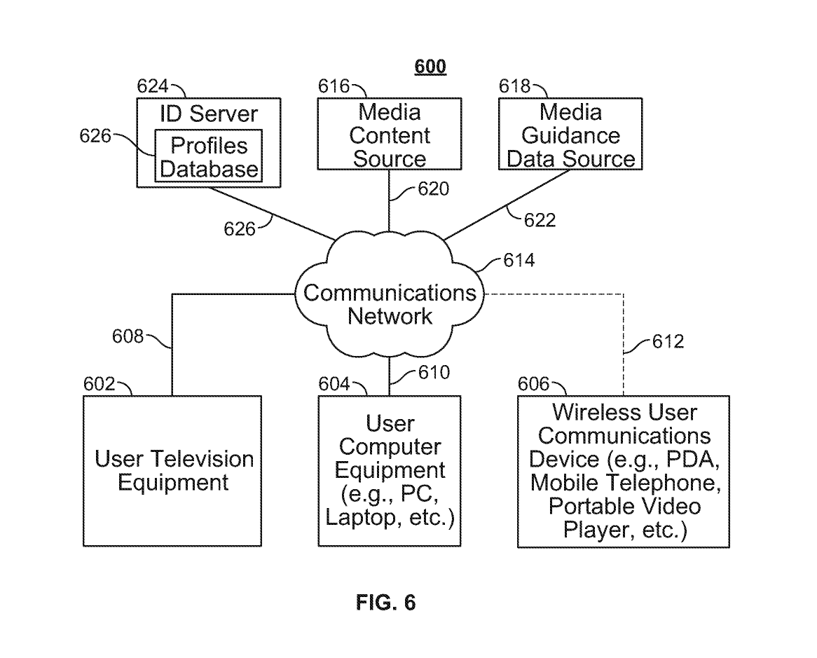

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 6. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

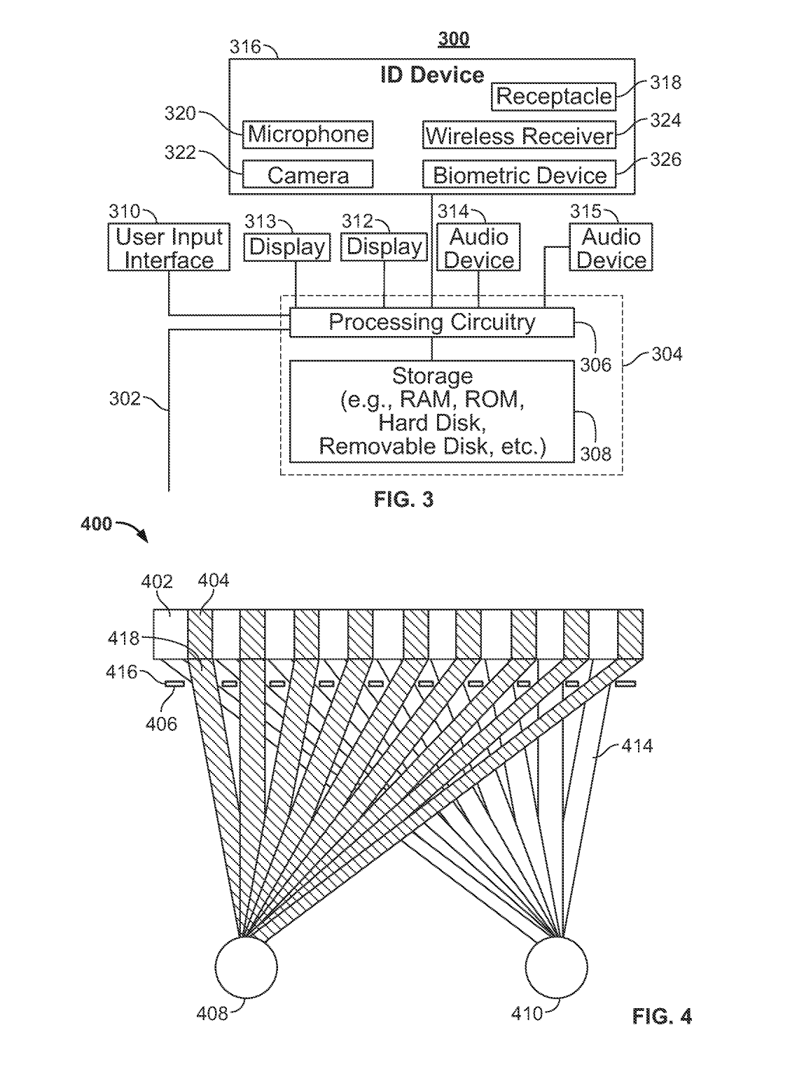

Users may access content and the media guidance application (and its display screens described above and below) from one or more of their user equipment devices. FIG. 3 shows a generalized embodiment of illustrative user equipment device 300. The elements of device 300 may be provided as an integrated device, combinations of integrated devices, or stand-alone units. For example, an integrated device may include several devices that share a common power supply or are connected with cables or are substantially contained within a single housing. More specific implementations of user equipment devices are discussed below in connection with FIG. 6. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 6). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 6, may be used to supplement storage 308 or instead of storage 308. In certain approaches, storage 308 includes one or more databases that store the media asset, media asset attributes, user profile, user identification data, user media access permissions, other user data, or a combination thereof.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). For example, multiple tuners may be used to simultaneously provide different, individualized media content to different users. If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. User equipment device 300 may include presentation devices, such as displays and audio devices. For example, display 312 may be provided as a stand-alone device or integrated with other elements of user equipment device 300. In certain approaches, user equipment device 300 includes a plurality of displays. For example, user equipment device 300 may include display 313. Although two displays are depicted to avoid overcomplicating the drawing, any appropriate number of displays may be provided. Displays 312 and 313 may be one or more of a monitor, a television, a liquid crystal display (LCD) for a mobile device, or any other suitable equipment for displaying visual images. In some embodiments, display 312 and display 313 may be HDTV-capable. In some embodiments, display 312 and display 313 may be a 3D display, and the interactive media guidance application and any suitable content may be displayed in 3D. In some embodiments, display 312 and display 313 are each a display on a multi-view screen. For example, display 312 and display 313 may each be a display on a parallax screen. A video card or graphics card may generate the output to display 312 and display 313. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. In certain approaches, display 312 and display 313 provide non-visual content. For example, display 312 and display 313 may be tactile displays, electro-mechanical displays, or Braille displays.

Audio device 314 may be provided as integrated with other elements of user equipment device 300 or may be a stand-alone unit. In certain approaches, user equipment device 300 includes a plurality of audio devices. For example, user equipment device 300 may include audio device 314 and audio device 315. Although two audio devices are depicted to avoid overcomplicating the drawing, any appropriate number of audio devices may be provided. In certain approaches, audio device 314 and audio device 315 are speakers. Additionally or alternatively, audio device 314 and audio device 315 may be audio output jacks to which a personal listening device, such as a set of headphones, may attach. Audio device 314 and audio device 315 may provide focused or directional sound to a specific, focused physical location. In certain approaches, audio device 314 and audio device 315 are parametric speakers, which use ultrasonic transduction to provide directional, audible sound (e.g., a “sound beam”). For example, audio device 314 may direct a first audio stream to a first user in a first location in a room, such that the first audio stream can be heard only by the first user in the first location. Audio device 315 may direct a second audio stream to a second user in a second location in a room, such that second audio stream can be heard only by the second user in the second location. In some implementations, audio devices 314 and 315 include wireless transmitters through which different audio data may be sent to different personal listening devices. For example, audio device 314 may wirelessly transmit a first audio stream (e.g., a streaming audio file) to a first wireless personal listening device. Audio device 315 may wirelessly transmit a second audio stream (e.g., a streaming audio file) to a second wireless personal listening device. The audio component of videos and other content displayed on display 312 and display 313 may be played through audio device 314 and audio device 315. In some embodiments, the audio component may be distributed to a receiver (not shown), which processes and outputs the audio via audio device 314 and audio device 315.

In some implementations, user equipment device 300 may include identification (ID) device 316 which detects and/or identifies a user or users in proximity to user equipment device 300. As used herein, a user is in proximity to user equipment device 300 when the user is positioned such that identification device 316 is able to detect the presence of the user (i.e., the user is within the “detectable range” of identification device 316). In certain approaches, when the user is in proximity to user equipment device 316, the user is able to receive media content presented by user equipment device 300. Identification device 316 may be provided as a stand-alone device or integrated with other elements of user equipment device 300 (such as processing circuitry 306 and storage 308).

Identification device 316 may include any suitable hardware and/or software to perform detection and identification operations. For example, identification device 316 may include any one or more of microphone 320, camera 322, receptacle 318, wireless receiver 324, and biometric device 326. Microphone 320 detects audio or acoustic information, and may receive sounds within the human-audible range and/or outside the audible range, such as ultrasound and infrasound. Camera 322 captures information within the human-visual spectrum and/or outside the visual spectrum. For example, camera 322 may capture infrared information, ultraviolet information, or any other suitable type of electromagnetic information. Biometric device 316 captures biological information about a user or users (using any of a number of sensing modalities) and uses this information to detect and/or identify the user or users, and may include any one or more of palm, fingerprint, and retinal readers. Receptacle 318 is configured to receive a plug, cable, or other connector, for example, from a personal electronic identification device, such as a dongle or a personal listening device (e.g., headphones).

In some implementations, identification device 316 of device 300 may be configured to track the movement of users in proximity to device 300. For example, identification device 316 may be capable of determining the position, distance from device 300, and trajectory of a user. As discussed above, identification device 316 may track the movement of users using any suitable method. Identification device 316 may communicate the trajectory information to control circuitry 304. Control circuitry 304 may then present an access-aligned media asset at an appropriate presentation device, such as display 312, display 313, audio device 314, and audio device 315. Access-aligned media content meets the media access permissions specified for a user. For example, media access permissions may be stored in a user profile. Additionally or alternatively, if there are other active users at the media device, the control circuitry 304 may adjust targeted media content and/or suggested media content accordingly for the users responsive to movement or repositioning of one or more of the users. For example, a user may move from a close proximity to display 312 to a close proximity to display 313. Control circuitry 304 may then adjust delivery of the access-aligned media asset for that user from display 312 to display 313. In some implementations user equipment device 300 detects and identifies users without receiving a user prompt to do so.

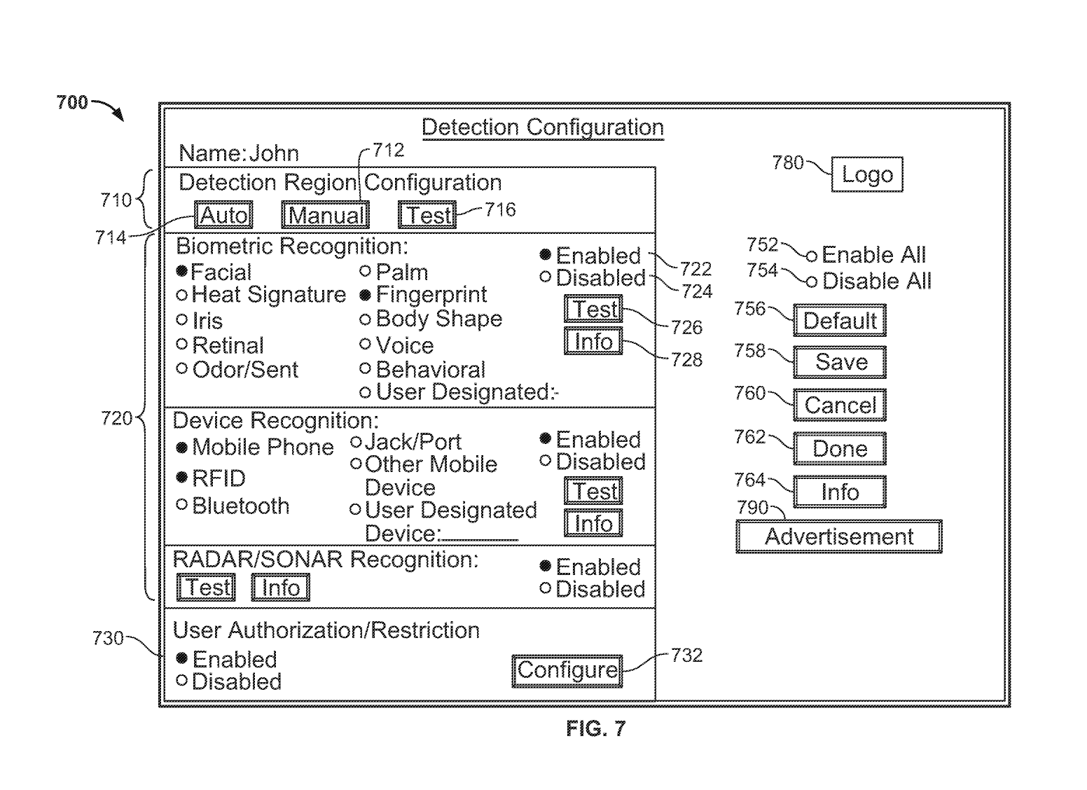

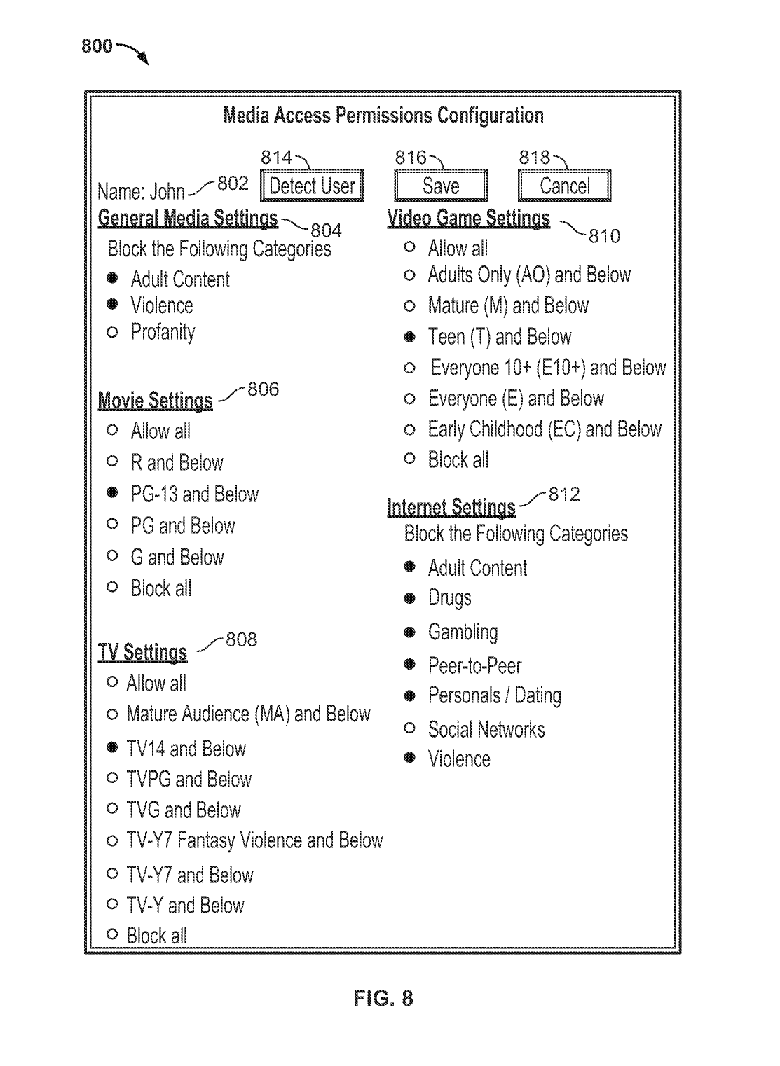

As used herein, a detected user refers to a user whose presence is detected by a device, but who may not yet be identified by the device. In certain embodiments, control circuitry 304 assigns default media access permissions to a detected, but not identified, user. In certain approaches, a detected user with assigned media access permissions is considered an identified user. Control circuitry 304 may log a detected and/or identified user into media device 300 and utilize profiles and/or information associated with the user to, for example, tailor media content for the logged in user. In some embodiments, control circuitry 304 may be able to detect, identify, and login more than one user automatically. This may allow control circuitry 304 to, for example, tailor media content to the combination of the logged in users without requiring manual input from the multiple users. The operations that control circuitry 304 may perform before, during, and after detection of one or more users are discussed in further detail below. The available operations of control circuitry 304 may be configured through, for example, the configuration menu screens described below in conjunction with FIGS. 7 and 8.

As used herein, an identified user refers to a user who is recognized sufficiently by a device to associate the user with a user profile. In some embodiments, the user may be associated with a group of users, as opposed to, or in addition to being associated with a unique user profile. For example, the user may be associated with the user's family, friends, age group, sex, and/or any other suitable group. In some implementations, user equipment device 300 uses identification device 316 and control circuitry 304 to perform a parental control check when a user is detected and/or identified near the user equipment device. For example, a user who had not previously been near the device, may approach the device. Upon identifying a user newly in proximity to the device 300, control circuitry 304 may log the identified user into device 300, for example, by adding an identifier associated with the user into an active user list stored in a database in memory 308. Control circuitry 304 then accesses a profile for the identified user stored locally in memory 308 or remotely on a server. The user profile may include media access permissions for the detected or identified user. Control circuitry 304 may utilize the profiles, for example, to deliver media content for the identified user that meets the media access permissions specified by the user profile (such media content referred to herein as “access-aligned media content” or an “access-aligned media asset”).

In some implementations, the device 300 detects, identifies, and logs in more than one user automatically. It may be desirable to handle multiple user situations to, for example, deliver access-aligned content to all active users of a device or devices when multiple users access content at the device or devices. For example, a parent may be watching a movie with violent content on his laptop or smartphone when, unbeknownst to the child's parent, a young child walks within viewing distance of the device displaying the violent content. In such a situation, identification device 316 may detect and identify the child. In response, control circuitry 304 may log in the child as an active user of device 300, retrieve a user profile of the child that includes the child's media access permissions, compare the child's media access permissions to the attributes of the displayed movie, and if a media access permissions conflict is detected prevent the child from viewing the violent content. A media access permissions conflict includes any discrepancy between attributes of content and media access permissions associated with a user. For example, parental control settings (stored as media access permissions in a profile, associated with a user) may stipulate that the user may not watch any movie that has a rating higher than “PG.” In such a situation, control circuitry 304 may detect a media access permissions conflict if, for example, the user becomes active at a device (i.e., is identified within proximity of) while content rated “PG-13” is being displayed. In some implementations, control circuitry 304 may prevent a user from viewing conflicting media content by presenting alternative, access-aligned media content (i.e., media content which satisfies the media access permissions of the user). The access-aligned media content for the child prevented from watching the “PG-13” movie may be, for example, a different movie, an edited version of the movie, an entirely different movie or media asset (e.g., an educational television show) or any other access-aligned media asset. In certain approaches, control circuitry 304 continues to present the first media content to the first user (e.g., the parent of the present example) and simultaneously presents the second or alternative media content to the second user (e.g., the child of the present example). For example, control circuitry 304 may present the first media content on display 312 and the second media content on display 313. In certain approaches, control circuitry 304 presents media content to a first user, but presents no media content to the second user.

As indicated above, access-aligned media assets may have substantially the same content as the provided content; however, profane language and/or adult content, or any other objectionable material (as defined by the media access permissions) may be edited, altered, and/or removed to produce an edited version of the conflicting content that does not conflict with the user's media access permissions. In certain implementations, control circuitry 304 edits the content of a media asset upon detection of a conflict to bring the asset in to alignment with a user's media access permissions. Additionally or alternatively, the access-aligned media content may be retrieved from memory. The access-aligned content may be stored in any suitable local or remote device and may be retrieved via a computer network from a remote server. Additionally or alternatively, the edited content may be produced in real-time. For example, control circuitry 304 of device 300 may detect profane language in content and automatically edit the profane language out if media access permission settings conflict with the detected profane language. In another example, control circuitry 304 of device 300 may detect a mature scene and automatically edit the mature scene out (e.g., by replacing the mature scene with a blank screen or message, or by shortening the media asset by removing the mature scene) if media access permission settings conflict with the detected profane language. In certain approaches, the systems and methods described herein may be used to provide targeted content, such as advertisements, simultaneously to multiple users based on media access permissions. For example, a parent may view a commercial for a grocery product and a child may view a commercial for a toy.

In certain approaches, when multiple users are present, control circuitry 304 delivers access-aligned content according to the common access permissions of substantially all of the multiple users. For example, when identification device 316 identifies multiple users at display 312, control circuitry 304 may compare the permissions of all identified users in the vicinity of device 312 and present (e.g., on display 313) media content that satisfies or approximately satisfies the media access permissions of substantially all of the identified users.

Additionally or alternatively, the media access permissions of a primary user may depend on the presence of one or more secondary users in proximity of the primary user, device 300, or both. In certain approaches control circuitry 304 delivers media content to a primary user only when a secondary user is present. For example, a child (i.e., the primary user) may be restricted from viewing a “PG-13” movie unless the child's parent (i.e., the secondary user) is present. If both the child and the parent are identified at user equipment device 300, control circuitry 304 may present a “PG-13” movie to the child, but if the parent is not identified, the child is restricted from viewing a “PG-13” movie. In certain approaches, control circuitry 304 may “unlock” or begin to present media content after identifying a secondary user in proximity of device 300, and continue to present the media asset even if the secondary user is no longer present. For example, control circuitry 304 may begin to present a “PG-13” movie to a child when the child's parent is identified, and continue to present the movie if the parent leaves. In certain approaches, control circuitry 304 stops presenting the media content when the secondary user is no longer present.

The example of a child as a primary user and parent as a secondary user is presented as an illustrative, but not limiting, embodiment of user permissions dependent on the presence of a secondary user. In practice, the primary user and secondary user may have any relationship. For example, a parent may identify one or more other individuals as secondary users associated with a child. An identifier of the one or more secondary users may be stored in the primary user's profile. The secondary users may be a part of a contact list (such as a friend list, buddy list, circle, etc.) stored locally (e.g., in storage 308 of control circuitry 304 of user equipment 300) or remotely, or a contact list associated with a second device (e.g., mobile phone), service (e.g., email contacts), website or application (e.g., HULU, NETFLIX, www.allrovi.com, or any other such websites or applications), or social network (e.g., FACEBOOK, TWITTER, MYSPACE, GOOGLE+, or any other such social networks) accessible to control circuitry 304 of the user equipment device 300. Control circuitry 304 establishes a communications link with the social network website via communications network 614 (discussed below with reference to FIG. 6). Control circuitry 304 may access the database to retrieve a contact list of secondary users with whom the access privileges of the primary user are modified. In certain approaches, the secondary user may be selected demographically. For example, control circuitry 304 may only present an “R” movie to a primary user when a secondary user over the age of 18 is also present. In certain approaches, the secondary user may be selected through a combination of criteria, for example, any user of the age of 18 associated with a particular contact list (established by, e.g., the primary user's parent or other master user of the device 300 as described below).

In certain approaches, one or more users may have master user privileges. A master user has full access rights and is able to configure, change, or override media access permissions for themselves and other users. Intermediate levels of privileges, in which a user can change some but not all media access permissions for themselves or other users, may also be defined.

It will be appreciated that while the discussion of media content has often used examples of video content, the principles of delivering access-aligned media content can be applied to other types of media content, such as audio content, music, images, video games, multimedia content, websites, applications, advertisements, etc. For example, in certain approaches, control circuitry 304 delivers a first audio content to audio device 314 and a second, different audio content that is access-aligned to a user of audio device 315. For example, access-aligned audio content may mute words, phrases, or songs, or may provide alternative words, phrases, or songs. In some implementations, control circuitry 304 may substantially decrease the volume of the output of audio content to an audio device upon conflict detection. The amount of volume decrease may be associated with how far the conflicted user is from the device providing the content. For example, identification device 316 may determine how far a user is from the user device. For example, if the conflicted user is relatively far from the device, the volume may not need to be decreased as much as if the user was relatively near to the device to prevent the user from hearing the conflicting content. Control circuitry 304 may deliver access-aligned audio content at audio devices (e.g., devices 314 and 315) and access-aligned video content at display devices (e.g., devices 312 and 313). Because many media assets include multiple content modalities (e.g., audio and visual), control circuitry 304 may be configured to adjust any one or more modalities, independently or in combination.

In certain approaches, identification device 316 identifies users without requiring users to make any affirmative actions by using biometric device 326 to perform a biometric recognition technique, such as facial recognition, heat signature recognition, odor recognition, body shape recognition, voice recognition, behavioral recognition, or any other suitable biometric recognition technique. In certain approaches, microphone 320 may detect a user's voice for voice recognition or password recognition. In certain approaches, camera 322 produces an image of the user, such as a visible light image or an infrared image, that is then used for biometric recognition. In certain approaches, identification device 316 identifies users using these techniques while the users are beyond a specified distance from the device to accurately identify a user. For example, the camera may require an image of the users entire face or body in order to identify the user. In some implementation, users are identified using biometric recognition techniques that may require the users to be within a specified distance to the device to accurately identify a user. For example, identification device 316 may utilize iris recognition, retinal recognition, palm recognition, finger print recognition, or any other such technique which requires the user to be in close proximity to the device.

Identification device 316 may also be configured to identify a user or users based on identification of a personal electronic identification device (e.g., a mobile device, such as an RFID device, mobile phone, headphones, goggles, dongle, Bluetooth device, etc.) that may be associated with the user or users. In certain approaches, the personal electronic identification device includes a radio frequency beacon, which emits a radio frequency signal. For example, wireless receiver 324 may recognize and identify such a personal electronic identification device using any suitable means, including, but not limited to, radio frequency identification, Bluetooth, Wi-Fi, WiMax, internet protocol, infrared signals, optical signals, Global Positioning System (GPS), any other suitable IEEE, industrial, or proprietary communication standards, or any other suitable electronic, optical, or auditory communication means. In certain approaches, receptacle 318 receives a plug, cable, or other connector of the personal electronic identification device, such as a dongle or a personal listening device (e.g., headphones). In certain approaches, the personal identification device includes a memory device in which the user profile is stored.

In certain approaches, identification device 316 may determine that a user is within a predetermined detection region of device 300, identify the user, and add the user to a list of active users of device 300. In certain approaches, the detection and identification of users as described herein does not require any affirmative action on the part of the user beyond. For example, detection and identification of users may be done automatically by media devices (e.g., using one or more of the biometric recognition techniques described above).

In some implementations, identification device 316 may use any suitable method to determine the distance and/or location of a user in relation to device 300. For example, control circuitry 304 may use received signal strength indication (RSSI) from a user's personal electronic identification device to determine the distance the user is to device 300. RSSI values may be triangulated to determine a user's location. Control circuitry 304 may also use, for example, triangulation and/or time difference of arrival techniques to determine a user's location in relation to device 300. For example, time difference of arrival values of sounds emanating from a user may be determined and used to approximately locate the user. In certain approaches, media device 300 may use acoustic location (e.g., with ultrasonic transmitters and receivers) to determine a user distance and/or location in relation to device 300. In certain implementations, control circuitry 304 may use optical changes recorded at an optical sensor (e.g., motion sensor) to determine a user distance and/or location in relation to device 300. Any suitable image processing, video processing, and/or computer vision technique may be used to determine a user's distance and/or location in relation to device 300. In certain approaches, media device 300 may use a GPS device to determine a user's location or distance in relation to device 300. For example, control circuitry 304 may identify a GPS device associated with a user, and receive location data for the device.

FIG. 4 depicts an illustrative parallax screen device 400 for presenting media content to a plurality of users based on the position of each user relative to the screen. Device 400 may be similar to user device 300 or user equipment 602, 604 or 606 (discussed below with reference to FIG. 6). Device 400 may include a processing device similar to control circuitry 304 of device 300. Device 400 may also include an identification device, similar to identification device 316 to detect and identify users and their positions relative to t device 400.

Device 400 includes first display set 404 and second display set 402. Display sets 402 and 404 may be similar to displays 312 and 313 of user device 300 in FIG. 3. Device 400 includes viewing barrier 406 positioned in from of display sets 402 and 404. Viewing barrier 406 includes a series of shields 416 and slits 418. Slits 418 allow first user 408 to see first display set 404 and also allow second user 410 to see second display set 402. Shields 416 prevent first user 408 from seeing second display set 402. Shields 416 also prevent second user 410 from seeing first display set 404. Display set 402 and display set 404 may operate independently of each other. Accordingly, first display set 404 provides first view 412 of a first access-aligned media asset to first user 408. Second display set 402 provides a second view 414 of a second asset-aligned media asset to second user 410.

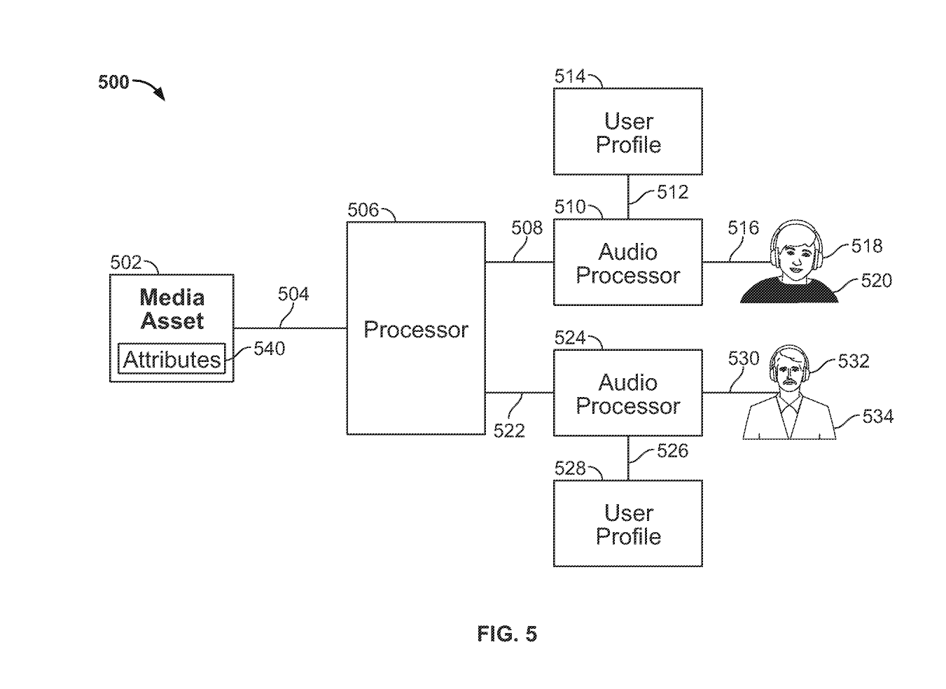

The principles of delivering access-aligned media content can also be applied to audio content. FIG. 5 is a block diagram of an illustrative audio device for presenting access-aligned audio content to a plurality of users. Device 500 may be similar, for example, to user device 300, or user equipment 602, 604, or 606 (discussed below with reference to FIG. 6). Device 500 includes processor 506 which may be similar to control circuitry 304 of device 300. For example, processor 506 may be based on any suitable processing circuitry, such as processing circuitry 306. Processor 506 receives media asset 502 via communications network 504, which may be similar to communications network 614 (discussed below with reference to FIG. 6). For example, media asset 502 may be retrieved from a server, such as media content source 416. Media asset 502 may also include media asset attributes 540, such as the words, subtitles, descriptions, ratings or other information related to media asset 502. For example, media asset attributes may be included as metadata associated with the media asset, or may be in the form of data separate from the media asset. Processor 506 transmits media asset 502 (and attributes 540) to audio processor 510 via communication line 508 and to audio processor 524 via communication line 522. Although two audio processors 510 and 524 are depicted to avoid overcomplicating the drawing, any appropriate number of audio processors may be provided. Audio processor 510 and audio processor 524 may each be similar to control circuitry 304 of device 300. For example, audio processor 510 and audio processor 524 may be based on any suitable processing circuitry, such as processing circuitry 306. Processor 506, audio processor 510, and audio processor 524 are depicted as separate components; however, in certain implementations, processor 506, audio processor 510, and audio processor 524 are implemented as a single processing device. For example, processor 506, audio processor 510, and audio processor 524 may be part of control circuitry 304.

Audio processor 510 retrieves user access permissions from user profile 514 associated with a first user 520 and stored in a memory. In certain approaches, audio processor 510 retrieves the user profile 514 from a profile database via a communication line 512. For example, audio processor 510 may retrieve user profile 514 from profile database 626 of identification server 624 via communications network 614 (discussed below with reference to FIG. 6). Audio processor 510 compares media access permissions of first user 520 with attributes 540 of the media asset 502. Audio processor 524 then delivers an access-aligned media asset via communication line 516 to personal listening device 518. For example, if the media access permissions of first user 520 restrict first user 520 from hearing vulgar language, audio processor 510 may deliver the audio content without the vulgar words. Audio processor 510 may mute words, phrases, or songs, or may provide alternative words, phrases, or songs. In certain approaches, audio processor 510 may substantially decrease the volume output of the audio content to personal listening device 518.

Similarly, audio processor 524 retrieves user access permissions from user profile 528 associated with a second user 534 and stored in a memory. In certain approaches, audio processor 524 retrieves user profile 528 from a profile database via communication line 526. For example, audio processor 524 may retrieve the user profile 628 from profile database 626 of identification server 624 via communications network 614 (discussed below with reference to FIG. 6). Audio processor 524 compares media access permissions of second user 534 with attributes 540 of the media asset 502. Audio processor 524 then delivers an access-aligned media asset via communication line 530 to personal listening device 532. For example, if the media access permissions of second user 520 restrict second user 520 from hearing vulgar language, audio processor 524 may deliver the audio content without the vulgar words. Audio processor 524 may mute words, phrases, or songs, or may provide alternative words, phrases, or songs. In certain approaches, audio processor 524 may substantially decrease the volume output of the audio content to personal listening device 532.

Audio device 518 and audio device 532 may be similar, for example, to audio device 314 or audio device 315. For example, audio device 518 and audio device 532 may include speakers or headphones. In certain approaches, audio content may be provided so that different users may receive different audio content in the same physical area, such as sitting in the same room or beside each other on a couch, without headphones. For example, audio device 518 and audio device 532, may provide directional audio output to specific, focused physical locations. For example, audio device 518 and audio device 532 may be parametric speakers. In certain approaches, device 500 provides differential audio output for different users with active noise cancellation. For example, device 500 may include a noise cancellation device, which emits cancellation waves, which interfere with the audio content in specific locations to silence or reduce the audio content volume (e.g., so that a child is prevented from hearing objectionable language in a film).

User equipment device 300 of FIG. 3 can be implemented in system 600 of FIG. 6 as user television equipment 602, user computer equipment 604, wireless user communications device 606, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 602, user computer equipment 604, or a wireless user communications device 606. For example, user television equipment 602 may, like some user computer equipment 604, be Internet-enabled, allowing for access to Internet content, while user computer equipment 604 may, like some television equipment 602, include a tuner, allowing for access to television programming. The media guidance application may have the same layout on various different types of user equipment or may be tailored to the display capabilities of the user equipment. For example, on user computer equipment 604, the guidance application may be provided as a web site accessed by a web browser. In another example, the guidance application may be scaled down for wireless user communications devices 606.

In system 600, there is typically more than one of each type of user equipment device but only one of each is shown in FIG. 6 to avoid overcomplicating the drawing. In addition, each user may utilize more than one type of user equipment device and also more than one of each type of user equipment device.

In some implementations, a user equipment device (e.g., user television equipment 602, user computer equipment 604, wireless user communications device 606) may be referred to as a “second screen device.” For example, a second screen device may supplement content presented on a first user equipment device, or may provide alternative content, such as access-aligned media content to a second user. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. In certain implementations, the settings include user profiles with media access permissions for one or more users. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 614. Namely, user television equipment 602, user computer equipment 604, and wireless user communications device 606 are coupled to communications network 614 via communications paths 608, 610, and 612, respectively. Communications network 614 may be one or more networks including the Internet, a mobile phone network, mobile voice or data network (e.g., a 4G or LTE network), cable network, public switched telephone network, or other types of communications network or combinations of communications networks. Paths 608, 610, and 612 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 612 is drawn with dotted lines to indicate that in the exemplary embodiment shown in FIG. 6 it is a wireless path and paths 608 and 610 are drawn as solid lines to indicate they are wired paths (although these paths may be wireless paths, if desired). Communications with the user equipment devices may be provided by one or more of these communications paths, but are shown as a single path in FIG. 6 to avoid overcomplicating the drawing.

Although communications paths are not drawn between user equipment devices, these devices may communicate directly with each other via communication paths, such as those described above in connection with paths 608, 610, and 612, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 614.

System 600 includes content source 616, media guidance data source 618, and identification (ID) server 624 coupled to communications network 614 via communication paths 620, 622, and 626 respectively. Paths 620, 622, and 626 may include any of the communication paths described above in connection with paths 608, 610, and 612. Communications with the content source 616, media guidance data source 618, and identification server 624 may be exchanged over one or more communications paths, but are shown as a single path in FIG. 6 to avoid overcomplicating the drawing. In addition, there may be more than one of each of content source 616, media guidance data source 618, and identification server 624, but only one of each is shown in FIG. 6 to avoid overcomplicating the drawing. (The different types of each of these sources are discussed below.) If desired, content source 616 and media guidance data source 618 may be integrated as one source device and may also be integrated individually or together with identification server 624. Although communications between sources 616 and 618, and 624 with user equipment devices 602, 604, and 606 are shown as through communications network 614, in some embodiments, sources 616 and 618, and identification server 624 may communicate directly with user equipment devices 602, 604, and 606 via communication paths (not shown) such as those described above in connection with paths 608, 610, and 612.

Content source 616 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 616 may be the originator of content (e.g., a television broadcaster, a Webcast provider, etc.) or may not be the originator of content (e.g., an on-demand content provider, an Internet provider of content of broadcast programs for downloading, etc.). Content source 616 may include cable sources, satellite providers, on-demand providers, Internet providers, over-the-top content providers, or other providers of content. Content source 616 may also include a remote media server used to store different types of content (including video content selected by a user) in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

In certain approaches, content source 616 stores multiple versions of a media asset. For example, content source 616 may store a standard version of a media asset and one or more edited versions of the media asset. In an edited version, profane language and/or mature content, other objectionable content, or any other type of content may be edited, altered, and/or removed. In certain approaches, content source 616 includes identifiers and media attributes, such as ratings, summaries, key words, clips, stills, genres, chapter markers and subtitles, to identify objectionable material that may be removed, for example, by control circuitry 304 of device 300 or user equipment 602, 604, or 606. Media asset attributes may be included as metadata associated with the media asset, or may be in the form of data separate from the media asset.

Identification server 624 may store information related to identifying users. In particular, identification server 624 may store user profiles, user identification data, user media access permissions, other user data, or a combination thereof. In certain approaches, identification server 624 stores biometric data associated with users (such as fingerprint or voice recognition data). In certain approaches, identification server 624 stores identification data for a personal electronic identification device, such as a radio frequency beacon, associated with a user. Identification server 624 may include a profiles database 626 that stores user profiles. The user profiles stored in database 626 may include media access permissions data. A processing device, such as control circuitry 304 of device 300, or user equipment 602, 604, or 606 may access identification server 624 to identify a detected user. For example, the processing device may obtain identification data from a user in proximity to a processing device and compare that data with data stored in a memory accessible to identification server 624 to identify the user. In certain approaches, the processing device retrieves media access permissions from a user profile stored in profiles database 626 on identification server 624.

Media guidance data source 618 may provide media guidance data, such as the media guidance data described above. Media guidance data source 618 may also provide attributes of media content, such as descriptions, ratings, subtitles, and chapter markers. Attributes of media content may be stored in a database on media guidance data source 618. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data, alternative media asset information, and other media guidance data may be provided to user equipment on multiple analog or digital television channels.

In some implementations, guidance data from media guidance data source 618 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 618 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 618 may provide user equipment devices 602, 604, and 606 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In certain approaches, a media guidance application compares attributes of media content with media access permissions of a user to deliver access-aligned media content. In some implementations, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 618) running on control circuitry of the remote server. When executed by control circuitry of the remote server (such as media guidance data source 618), the media guidance application may instruct the control circuitry to generate the guidance application displays and transmit the generated displays to the user equipment devices. The server application may instruct the control circuitry of the media guidance data source 618 to transmit data for storage on the user equipment, and the client application may instruct control circuitry of the receiving user equipment to generate the guidance application displays.

Content and/or media guidance data delivered to user equipment devices 602, 604, and 606 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 600 is intended to illustrate a number of approaches, or network configurations, by which user equipment devices and sources of content and guidance data may communicate with each other for the purpose of controlling access to media content and providing media guidance. The implementations described herein may be applied in any one or a subset of these approaches, or in a system employing other approaches for controlling access to content and providing media guidance. The following four approaches provide specific illustrations of the generalized example of FIG. 6.

In one approach, user equipment devices may communicate with each other within a home network. User equipment devices can communicate with each other directly via short-range point-to-point communication schemes described above, via indirect paths through a hub or other similar device provided on a home network, or via communications network 614. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., media access permissions, recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 616 to access content. Specifically, within a home, users of user television equipment 602 and user computer equipment 604 may access the media guidance application to navigate among and locate desirable content. Users may also access the media guidance application outside of the home using wireless user communications devices 606 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 614. These cloud resources may include one or more content sources 616 and one or more media guidance data sources 618. In addition or in the alternative, the remote computing sites may include other user equipment devices, such as user television equipment 602, user computer equipment 604, and wireless user communications device 606. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, media access control, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services by which user-sourced content is distributed for viewing by others on connected devices. These cloud-based services may allow a user equipment device to store content to the cloud and to receive content from the cloud rather than storing content locally and accessing locally-stored content. For example, media content and alternative versions or access-aligned media content, may be stored and accessed using cloud-based services.

A user may use various content capture devices, such as camcorders, digital cameras with video mode, audio recorders, mobile phones, and handheld computing devices, to record content. The user can upload content to a content storage service on the cloud either directly, for example, from user computer equipment 604 or wireless user communications device 606 having content capture feature. Alternatively, the user can first transfer the content to a user equipment device, such as user computer equipment 604. The user equipment device storing the content uploads the content to the cloud using a data transmission service on communications network 614. In some embodiments, the user equipment device itself is a cloud resource, and other user equipment devices can access the content (or edited version of the content) directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the user identification and access alignment processing operations performed by processing circuitry described in relation to FIG. 3.

In some embodiments, a media device, for example, user equipment device 300 or user equipment 602, 604, and 606, may be capable of detecting and identifying users, accessing a profile with media access permissions for the users, and delivering access-aligned media content to the users. For example, control circuitry 304 may deliver a first media asset on display 312 and/or audio device 314 to a first user or group of users according to media access permissions of the first user or group of users, and simultaneously deliver a second media asset on display 313 and/or audio device 315 to a second user or group of users according to media access permissions of the second user or group of users.

As discussed above, control circuitry 304 may be configured to automatically detect and identify a user by using, for example, identification device 316. Subsequently, control circuitry 304 may regard the user as an active user of the user equipment device or another user equipment device by logging the user onto an active user list. In some implementations, a user can configure detection and identification methods and options through an interface like detection configuration screen 700 of FIG. 7. Detection configuration screen 700 may be accessed by a user, for example, by selection of options region 126 in screen 100 of FIG. 1.

Detection configuration screen 700 may include detection region configuration options 710, recognition configuration options 720, and user authorization/restriction options 730. In some implementations, configuration selections may be made for the user performing the configuration, for another user (such as a child), a local device, or any other suitable device. The configuration selections may be stored in any suitable local or remote location (for example, storage 308 of FIG. 3). In some implementations, the configuration selections may apply to a particular user by, for example, storing the selections in a respective user profile.

Detection region configuration options 710 may allow a user to define a proximity and/or region near a media device such that, when a user is within the proximity and/or region, the user will be considered an active user of the media device. In certain approaches, control circuitry 304 provides options to allow a user input boundaries of the detection region, such that when a user is within the boundaries, control circuitry 304 logs the user as an active user at the associated device; otherwise the user is not considered an active user at the associated device. For example, if a user sits down in front of a first device and control circuitry 304 detects the user within the configured region, control circuitry 304 may automatically log the user into the active user list of the device so that, for example, the user's media access permissions are available to the first device.

In some implementations, configuration of the detection region using detection configuration screen 700 may avoid a situation where a user is detected at a media device, but actually does not intend to use the device. For example, a user may be cooking in a kitchen far from the device; however, control circuitry 304 may still detect and identify the user despite the fact that a user probably does not wish to utilize the device if the user is far from the device. Accordingly, using detection region configuration option 710, the detection region can be configured such that control circuitry 304 does not detect the user or log the user onto an active user list. In some implementations, identification device 316 may recognize objects within the viewable range of one or more displays and adjust the detection region such that, when a user is behind the object, the user would not be considered an active user at the respective media device. For example, identification device 316 may recognize a wall within the display's viewable range. As such, the media device may be configured to set the detection region such that the wall is outside the detection region or is part of a border of the detection region. In such an implementation, any user behind the wall would not be considered an active user at the device.

In some implementations, the configuration of the detection region may be based on viewing angles of, for example, display 312 and display 313. For example, a detection region's border may be automatically or manually limited so that it is within a reasonable viewing angle of the respective media device's displays, and may be automatically or manually adjusted to identify viewing regions for each display. In some implementations, the reasonable viewing angle may be manually configured by a user and/or system operator. In some implementations, the reasonable viewing angle may be intrinsic to the display or displays.

In some implementations, control circuitry 304 enables manual configuration of the detection regions of a media device by, for example, upon receiving a user input selection of “Manual” button 712 in configuration options 710. If button 712 is selected, control circuitry 304 enables a user to manually configure the detection regions. For example, control circuitry 304 may detect, with identification device 316, a person walking in a particular area. If the user configuring the device would like people walking in that area to be considered active by the device, control circuitry 304 may request and receive verbal or electronic input from a user to affirm that the current position of the user is to be part of the device detection region. In certain approaches, control circuitry 304 receives verbal or electronic input from a user to affirm that the current location of the user is not to be part of the detection region.

Additionally or alternatively, control circuitry 304 may automatically configure the detection regions upon receiving a user input selection of “Auto” button 714 in configurations options 710. Control circuitry 304 may automatically configure the detection regions using any suitable technique. For example, a device may recognize that a couch is positioned to face the device. In such a case, control circuitry 304 may add the couch to the device's detection region. If the couch is positioned to face away from the device, control circuitry 304 may not add the couch to the device's detection region. In some embodiments, the detection regions may adapt in real-time. For example, mobile devices may be associated with a particular detection region around the mobile device that adapts to the surroundings such as walls, furniture, or other objects around mobile device.

Once detection regions are configured, control circuitry 304 enables a user to test the detection region configuration by selecting button 716. Upon receiving a user input “Test” selection from button 716, control circuitry 304 may test the detection region configuration using any suitable technique. For example, control circuitry 304 may, with identification device 316, detect a user positioned in different places relative to a user device and provide output, for example, on displays 312 and 313 or audio devices 314 and 315, to indicate when the user is within the configured detection regions and/or outside the configured detection region for any suitable amount of time. Control circuitry 304, thereby, enables the user to determine whether a device's detection settings and performance are satisfactory.

In some embodiments, control circuitry 304 may provide recognition configuration options 720 for configuring what techniques control circuitry 304 and identification device 316 may use to detect, track movement of, and/or identify users within the detection regions of the device 300. For example, control circuitry 304 may provide input options to enable or disable detecting, tracking movement of, and/or identifying a user using any suitable biometric recognition technique, any suitable device recognition technique, any suitable radar and/or sonar recognition technique, and/or any other suitable recognition technique. Identification device 316 may utilize any suitable image processing, video processing, and/or computer vision technique and/or any other suitable technique to detect, track movement of, locate and/or identify users, and/or determine any other suitable information regarding a user within the device's detectable range. For example, control circuitry 304 may receive a user input selection from button 722 to enable biometric recognition capabilities, or alternatively, receive a user input selection from button 724 to disable biometric recognition capabilities. The biometric techniques may include any of the techniques described above in connection with FIG. 3 or any other suitable technique, and may be selected individually, in groups, or combinations.

In some implementations, control circuitry 304 and identification device 316 detect, track, and/or identify a user by way of recognizing a device associated with a user. For example, identification device 316 may detect a personal electronic identification device, such as a mobile device (e.g., RFID device, mobile phone, headphones, goggles, dongle, Bluetooth device, etc.) that is associated with a particular user or users. In some implementations, when the personal electronic identification device is within a detectable range of a media device (e.g., the entire area within which the device is capable of detecting a user) and/or within the configured detection region of a media device (e.g., the range as configured with options 710), the control circuitry 304 may be capable of identifying the personal electronic identification device through any suitable identification method (e.g., RFID, detection of the mobile device's media access control (MAC) address, and/or any other suitable identification method). After control circuitry 304 and identification device 316 identify the personal electronic identification device, control circuitry 304 may then identify the user associated with the mobile device by, for example, looking up information associated with the personal electronic identification device from a server and/or local storage. In some implementations, control circuitry 304 receives information about the associated user or users from the personal electronic identification device. The information about the associated user or users may be stored in the personal electronic identification device and/or at a remote server. In certain approaches, the personal identification device includes a memory device that stores a user profile including media access permissions, in the memory device.

In some implementations, control circuitry 304 detects, but does not identify, a user and/or personal electronic identification device. For example, control circuitry 304 may receive Bluetooth communication from a personal electronic identification device near the media device. In response to detecting the Bluetooth communications, the control circuitry 304 may determine that a user is within a detectable range of the media device (e.g., the entire area within which the device is capable of detecting a user) and/or that a user is within the configured detection region of the media device (e.g., the range as configured with options 710). In certain approaches, control circuitry 304 requests configuration of media access permissions upon detecting, but not identifying, a user. In certain approaches, control circuitry 304 assigns default media access permissions upon detecting, but not identifying, a user. These default media access permissions may depend on characteristics of the detected user that are observed or predicted by control circuitry 304 based on data received from identification device 316. For example, identification device 316 may detect the presence of an individual and estimate their height (e.g., based on image or acoustic data). If the estimated height is below a threshold stored in memory (e.g., four feet), control circuitry may assign a default set of “child” media access permissions to the user. Device 300 may be configured with one or more such sets of default media access permissions that can be assigned to unidentified users or identified users who are not otherwise associated with a set of media access permissions.

In some implementations, control circuitry 304 provides “Test” button 726 in display screen 700. Upon receiving a user input selecting “Test” button 726, control circuitry 304 and identification device 316 may initiate detection and identification processes to determine whether a user can be identified with the configurations specified in screen 700. Control circuitry 304 additionally or alternatively provides “Info” button 728. Upon receiving a user input selecting “Info” button 728, control circuitry 304 provides additional information about the configuration options 720. For example, control circuitry 304 may then provide descriptions of each detection technique.

In some implementations, control circuitry 304 provides “Enable All” option 752 on screen 700 to enable all available options related to the detection configuration. Control circuitry 304 may provide “Disable All” option 754 on screen 700 to disable all available options related to the detection configuration. Control circuitry 304 may provide “Default” option 756 for setting default detection configuration options. Control circuitry 304 may provide “Save” option 758. Upon receiving a user input selecting “Save” option 758, control circuitry 304 saves the configuration, for example, in storage 308. In certain approaches, control circuitry 304 saves the configuration to a server, such as identification server 624. Control circuitry 304 may provide “Cancel” option 760 to cancel any changes from previous configuration options. Control circuitry 304 may provide “Done” option 762. Upon receiving a user input selecting “Done” option 762, control circuitry 304 closes screen 700 and saves the configuration changes, for example, to storage 308 or to identification server 624. Control circuitry 304 may provide “Info” button 764. Upon receiving a user input “Info” selection from button 764, control circuitry 304 provides additional information about screen 700 and the configuration options. For example, control circuitry 304 may then provide instructions for how to configure the detection techniques.

In some implementations, control circuitry 304 provides authorization/restriction options 730 for configuring who is authorized and/or restricted from a particular device or devices. For example, though control circuitry may detect many users at a device, owner of the device may not want every detected user to have access to the device, or may want to restrict actions that other users can perform once they have gained access to the device. When the user authorization/restriction option 730 is enabled, and control circuitry 304 receives a user input selecting “Configure” button 723, control circuitry 304 may display one or more selectable options, such as options to identify a specific user to whom to grant or restrict access to the media device.

In some implementations, control circuitry 304 may provide advertisement 790, which may have the same or similar functionality as advertisement 124 of FIG. 1. Additionally or alternatively, control circuitry 304 may display logo 780 identifying the sponsor of the software application that provides the media multiple-user use and access functionality. Advertisement 790 and logo 780 may be placed in any suitable location and in any suitable configuration within screen 700.

In certain approaches, control circuitry 304 accesses a user profile that includes media access permissions for a detected or identified user. Control circuitry 304 may utilize a user profile to deliver content substantially immediately to a user in accordance with the media access permissions of the user. A user profile may identify access permissions and restrictions for various media types including, but not limited to, movies, video, television, video games, Internet content, and music. For example, a parent may define access permissions for a child to prevent the child from viewing or purchasing Smartphone applications with mature content. A user profile may be stored, for example, in storage 308 of device 300. Additionally or alternatively, a user profile may be stored in a database on a server, such as profile database 626 on identification server 624. A user profile may be accessible by control circuitry 304 whenever a user wishes to receive media content, regardless of the user's location. For example, control circuitry 304 of a user device 300 may access a profile for a child in the child's own home and may also access the profile of the child when the child is at a friend's home. In this way, a user will only have access to media content that is aligned with the access permissions of the user profile, regardless of the user's location.

FIG. 8 shows an illustrative display screen 800 of a media access permissions configuration menu for configuring media access permissions for a user. Display screen 800 of FIG. 8 may be generated by control circuitry 304 of the user device responsive to receiving a user selection to configure media access permissions. For example, options 126 of screen 100 may include a button for configuring media access permissions. In certain approaches, control circuitry 304 generates display screen 800 only after detecting and identifying a master user. A master user has full access rights and is able to configure media access permissions for him or herself and optionally one or more additional users.

Display screen 800 includes user identification 802. In the depicted example, user identification 802 includes the name of the user and is populated automatically by control circuitry 304 upon identification of the user. Display screen 800 also includes a button 814 that is selectable to trigger device 300 to detect a user for whom media access permissions can be configured. When control circuitry 304 receives a user input selecting “Detect User” button 814, the control circuitry 304 may initiate a detection process. For example, identification device 316 may use microphone 320, camera 322, biometric device 326, wireless receiver 324 or receptacle 318 to receive data that identifies a specific user. Control circuitry 304 may then store the received data from identification device 316 in a database in storage (such as storage 308 or as part of a profile in profile database 626 of identification server 624).

Display screen 800 includes several user input options for configuring media access permissions for a user. In particular, control circuitry 304 of the media device provides general media setting options 804, movie settings options 806, TV settings options 808, video games settings options 810, and internet settings options 812. General media settings options 804 allow a user profile to be configured to block or allow certain types of content across all media formats. For example, a user profile may be configured to restrict access to all adult content, violence or profanity, regardless of media format. In the depicted example, the “Adult Content” and “Violence” categories are selected to be blocked. In certain approaches, these categories may include a scale for adjusting the extent to which a category is blocked. For example, the violence category may include a scale of 1-10, where selecting “10” blocks all form of violence, selecting “1” allows all forms of violence, and selecting values in between 1-10 allows intermediate levels of violence.

Movie settings options 806 allow a user profile to be configured to restrict or to allow certain types of movies. For example, movie settings may include options for allowing movies based on a ratings system. In the depicted example, the movie settings can be configured to allow all movies, allow R and below, allow PG-13 and below, allow PG and below, allow G and below, or to block all. The movie ratings depicted on screen 800 of FIG. 8 are a trademark of the Motion Picture Association of America. In the depicted example, the PG-13 and below option is selected.

TV settings options 808 allow a user to restrict different types of television media content. In certain approaches, the TV settings may be based on a rating system such as the TV Parental Guidelines ratings system. For example, the TV settings may be configured to allow all, allow Mature Audience (MA) and below, allow TV-14 and below, allow TV-PG and below, allow TV-G and below, allow TV-Y7 fantasy violence and below, allow TV-Y7 and below, allow TV-Y and below, or to block all. In the depicted example, the “TV-14 and below” option is selected. The television media content referred to herein need not be broadcast over standard television transmission mediums, but includes content made for or previously broadcast on television which is thereafter transmitted by other means (e.g., the Internet).

Video games settings options 810 may be based on a ratings system, such as the Entertainment Software Rating Board (ESRB) rating system. For example, the video games settings may be configured to allow all video games, allow Adults Only (AO) and below, allow Mature (M) and below, allow Teen (T) and below, allow Everyone 10 and Older (E10+) and below, allow Everyone (E) and below, allow Early Childhood (EC) and below, or to block all. In the depicted example, the “Teen (T) and below” option is selected.

Control circuitry 304 provides Internet settings options 812 on screen 800 to configure the access permissions for media content received via the Internet. For example, the Internet settings may be configured to block certain categories such as adult content, drugs, gambling, peer-to-peer, personals and dating, social networks and violence. In certain approaches, the Internet settings may include a rating scale to adjust the extent to which content from each of these categories is allowed or blocked. In certain approaches the internet settings options 812 include options to block specific internet websites. In the depicted example, the categories for Adult Content, Drugs, Gambling, Peer-to-Peer, Personals/Dating, and Violence are selected to be blocked.

When control circuitry 304 receives a user input selecting “Save” button 816, the control circuitry 304 saves the media access permissions configuration to a user profile associated with the detected user. For example, control circuitry 304 may save the media access permissions to a user profile stored in memory 308 of device 300 or in a database, such as profile database 626 in identification server 624. If the control circuitry 304 receives a user input selecting “Cancel” button 818, then control circuitry 304 does not modify the user profile.

In certain approaches, control circuitry 304 detects and identifies users, accesses a profile with media access permissions associated for each of the users, then delivers access-aligned media content to the users. Control circuitry 304 may deliver different media assets to different users. For example, control circuitry 304 may deliver a first media asset on display 312 and/or audio device 314 to a first user or group of users such that the first media asset satisfies the media access permissions of the first user or group of users and simultaneously deliver a second media asset on display 313 and/or audio device 315 to a second user or group of users such that the second media asset satisfies the to media access permissions of the second user or group of users.

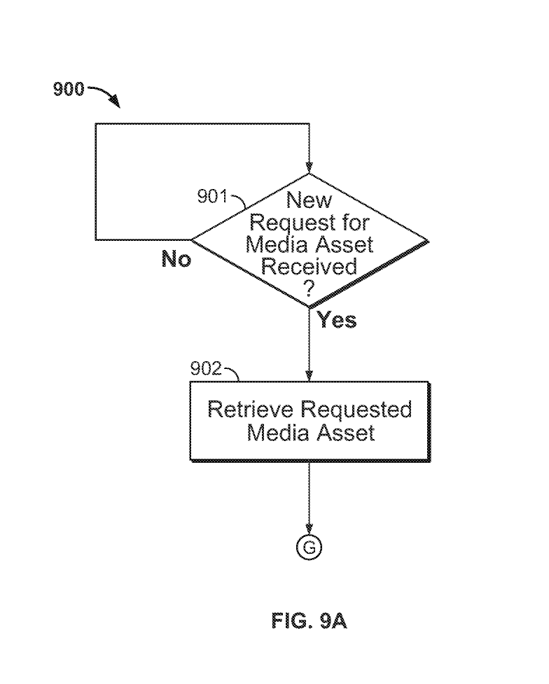

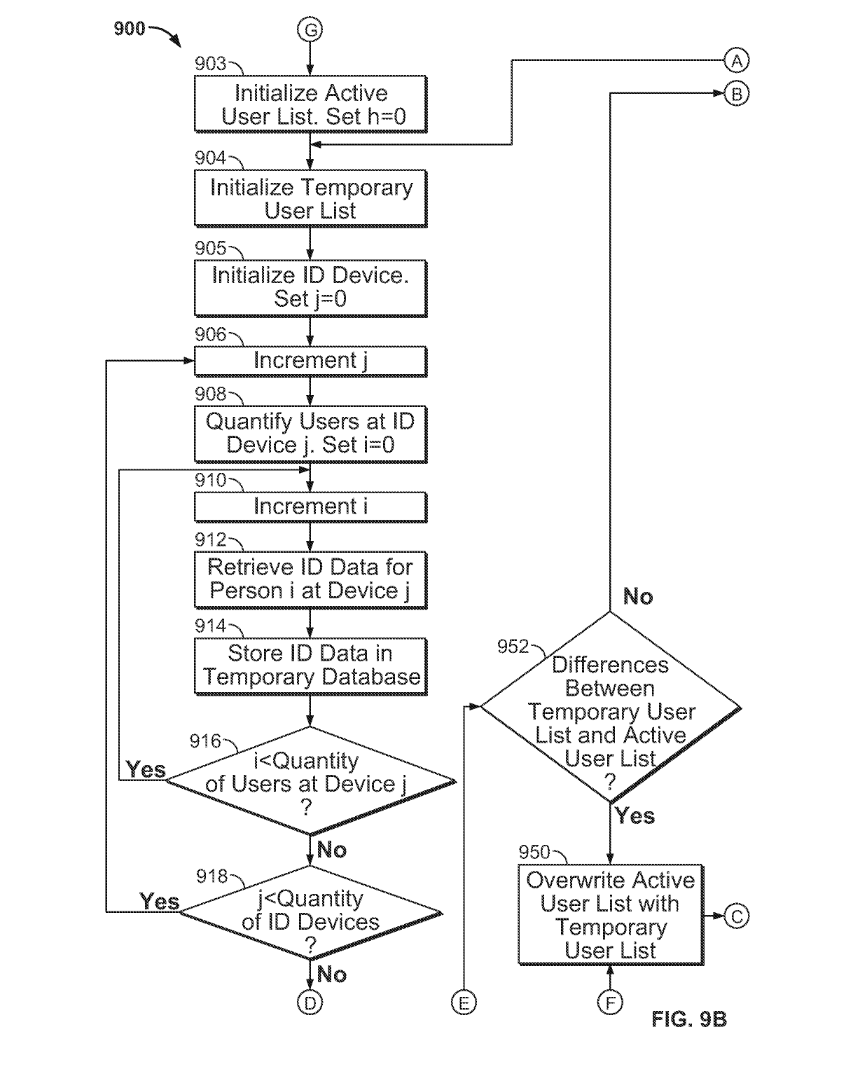

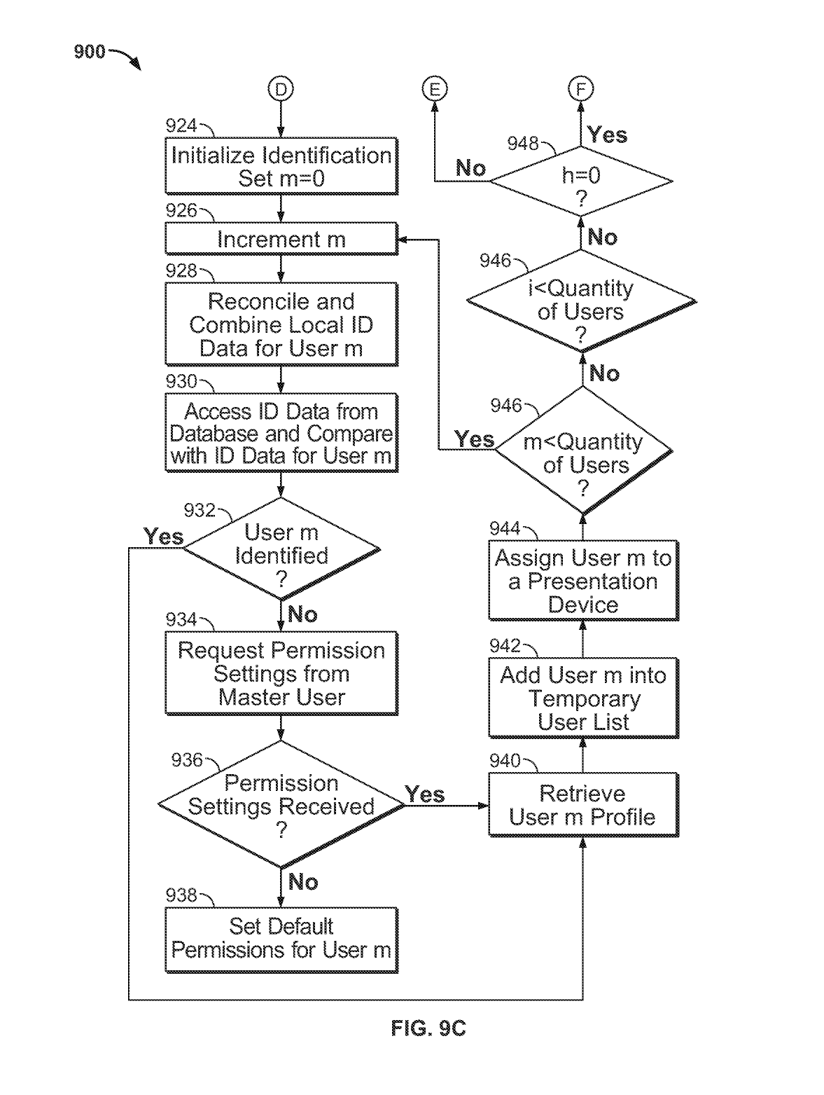

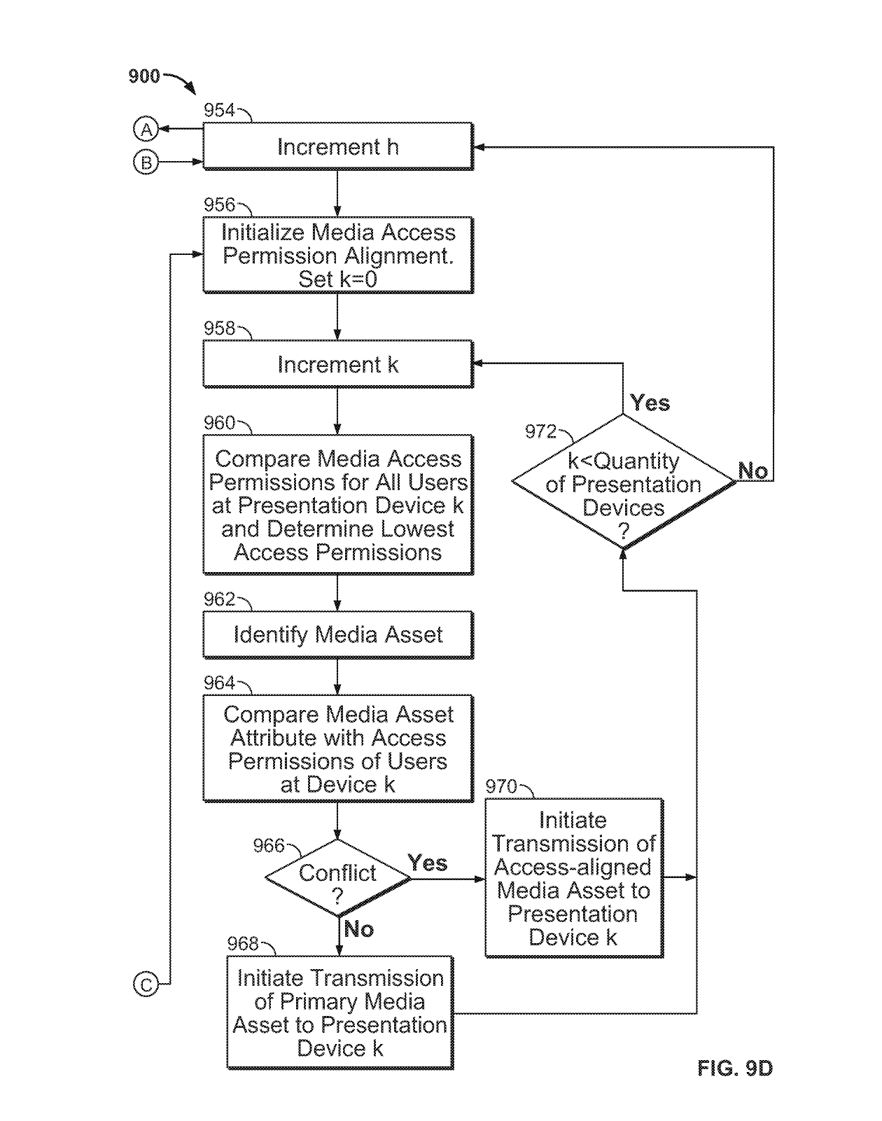

The flow diagram of FIG. 9 serves to illustrate some of the processes involved in some implementations of the systems and methods of the present disclosure. In particular, the flow diagram 900 of FIG. 9 illustrates processes for providing individualized and access-aligned media content. The steps of flow diagram 900 are performed by a processing device, such as control circuitry 304 of FIG. 3. The processing device may be part of a user device, such as user device 300 or user equipment 602, 604, or 606. Where appropriate, these processes may, for example, be implemented completely in the processing circuitry of a user equipment device, such as control circuitry 304 of FIG. 3, or may be implemented at least partially in a source remote from the user equipment devices.

At step 901, the processing device checks for a request to access a media asset. For example, the processing device may receive user input selecting a particular movie, channel, website, song, video game, or other media asset. In some implementations, a request to access a media asset includes a channel change command (e.g., initiated by a user pressing an “up” or “down” channel button on a remote control). In some implementations, a request to access a media asset includes a user selection of a “Surprise Me” icon or button in a media guidance application to which the media guidance application responds by providing a media asset not expected in advance by the user. In some implementations, a request to access a media asset includes a user selection of a video clip or series of clips, such as a series of movie trailers. In some implementations, the request to access a media asset includes a signal indicating that a user equipment device, such as user device 300, has been turned on and thus that a media asset (e.g., a default media asset or a media asset corresponding to a previously tuned channel) should be presented. The processing device continually checks for such requests, and, if at any time during the execution of steps of flow diagram 900, a request is received, the processing device proceeds to step 902 by retrieving the requested media asset.

In certain approaches, the requested media asset is stored locally, for example, in storage 308 of FIG. 3. For example, the media asset may be stored on a disc or other removable storage media, such as a DVD. In certain approaches, the media asset is located in remote memory, such as on a server. For example, the media asset may be stored on media content server 616 and retrieved by the processing device via communications network 614. The media asset is described by and includes media asset attributes. For example, the media asset may have an attribute that identifies the rating of a movie. In certain approaches, the media asset attributes include subtitles to identify language used in the movie. In certain approaches, the media asset attributes include identifiers or bookmarks to identify objectionable scenes, images or audio. For example, media asset attributes may be included as metadata associated with the media asset, or may be in the form of data separate from the media asset. Media asset attributes may be included as metadata associated with the media asset, or may be in the form of data separate from the media asset. The media asset attributes may be retrieved by the processing device, for example, from media content source 616 or media guidance data source 418.

At step 903, the processing device initializes an active user list and sets a counter h to 0. The active user list is used to record and track the users at a media device, such as user device 300. The active user list may be stored locally, for example, in storage 308 of device 300. Additionally or alternatively, the active user list may be stored remotely (e.g., on identification server 624). The counter h is used by the processing device to track the iterations of flow diagram 900. The counter h may be implemented by control circuitry 304 of FIG. 3 and, in certain approaches, may be stored in memory, such as storage 308 of FIG. 3. At step 904, the processing device initializes a temporary user list. The temporary user list is used by the processing device to temporarily store identified users during the detection and identification steps, as described in further detail below. The temporary user list may be stored locally, for example, in storage 308 of device 300. Additionally or alternatively, the temporary user list may be stored remotely (e.g., on identification server 624).

At step 905, the processing device initializes an identification (ID) device and sets a counter j to 0. The ID device may be similar to identification device 316 of device 300 in FIG. 3. An ID device may be provided as a stand-alone device or integrated with other elements of a user equipment device, such as device 300. The processing device utilizes the ID device to search for a detect users in the vicinity of the user device. The ID device may include any suitable hardware and/or software to perform detection and identification operations. For example, ID device may be or include a microphone, camera, receptacle, wireless receiver, biometric device and/or other suitable hardware or software. In certain approaches, the processing device accesses a plurality of ID devices and performs a plurality of detection and identification operations. The counter j is used to track the number of ID devices utilized by the processing device while executing the steps of flow diagram 900 to detect and identify users. The counter j may be implemented by control circuitry 304 of FIG. 3 and may be stored in memory such as storage 308 of FIG. 3. At step 906, the processing device increments j, which identifies the active ID device (e.g., ID device j). For example, j is set equal to 1 in a first iteration, indicating that the processing device is executing the subsequent steps with respect to ID device 1 (e.g., a first ID device).

At step 908, the processing device quantifies the users in the vicinity of the ID device j. For example, the processing device may utilize ID device j to capture an image of the area near ID device j and use an image processing algorithm to quantify the number of users in the image. The processing device may store a value for the quantity of users, for example, in storage 308 of device 300. At step 908, the processing device additionally sets a counter i to 0. The counter i is used to track the users as they are detected by the ID and processing devices, as will be described in further detail below. The counter i may be implemented by control circuitry 304 of FIG. 3 and may be stored in memory, such as storage 308 of FIG. 3. The processing device increments the counter i at step 910, indicating that the processing device is performing steps relating to user i. For example, i is set equal to 1 in the first iteration, indicating that the subsequent process steps will be performed for user 1 (e.g., a first user).

The processing device executes step 912 by retrieving identification (ID) data for user i at ID device j. Retrieving ID data may be accomplished by the processing device using any appropriate hardware or software associated with the device including any of the identification devices discussed herein with references to identification device 316 of FIG. 3. Retrieving ID data may include capturing infrared information, ultraviolet information or other information. Retrieving ID data may additionally or alternatively include retrieving palm, fingerprint, retinal data, or other biometric data. Retrieving ID data may include selecting facial recognition data, heat recognition data, odor recognition data, body shape recognition data, voice recognition data, behavioral recognition data or any other suitable biometric recognition data. Additionally, or alternatively, retrieving identification data may include retrieving data from a personal electronic device associated with a user such as any personal electronic device described herein. For example, a wireless receiver in communication with the processing device may recognize and identify a personal electronic device using any suitable means including, but not limited to, radio frequency identification, Bluetooth Wi-Fi, WiMax, internet protocol, infrared signals, optical signals, or any other suitable industrial or proprietary communication standard or any other suitable electronic, optical or auditory communication means. In certain approaches, retrieving ID data includes receiving a plug, cable receptacle or other connector associated with a personal identification device, such as a dongle, or a personal listening device such, as a pair of headphones. In certain approaches, retrieving ID data includes accessing identification data stored in a memory device of a personal identification device.

After retrieving identification data for user i at ID device j, the processing device stores the identification data as temporary identification data. For example, the processing device may store the identification data locally in memory, such as in storage 308 of device 300. Additionally or alternatively, the processing device may store the identification data in a remote location, such as on a server. After storing the temporary identification data, the processing device performs step 916 by comparing the counter i with the quantity of users at ID device j. The processing device thereby determines whether identification data has been retrieved for all users at ID device j. The processing device will continue to retrieve data for each user at ID device j until it has retrieved temporary identification data for all detected users. For example, if, at step 916, the processing device determines that counter i is less than the quantity of detected users at ID device j, then the processing device returns to process step 910 and performs ID data retrieval steps (i.e., steps 910, 920, 914, and 916). The processing device will continue to retrieve identification data until temporary identification data is retrieved for each detected user.

If, at step 916, the counter i is not less than the quantity of detected users at device j, then identification data has been retrieved by the ID device j for each detected user. The processing device then executes step 918 and determines whether temporary identification data has been retrieved by each ID device. The processing device compares the value of counter j to the quantity of ID devices. If the counter j is less than the quantity of ID devices, then the processing device returns to process step 906 and performs the ID data retrieval steps (i.e., 906, 908, 910, 912, 914, 916, and 918) with a different ID device for each detected user. The processing device thereby retrieves ID data for each detected user with each ID device. Accordingly, the counter j is incremented with each iteration. If, at step 918, the counter j is not less than the quantity of ID devices, then temporary identification data has been retrieved by the processing device with each ID device for each detected user. The processing device then proceeds to perform identification processes to identify each user.

At step 924, the processing device initializes the identification process by setting a counter m to 0. The counter m is used to track the users during the identification process steps described below. The counter m may be implemented by control circuitry 304 of FIG. 3 and may be stored in memory such as storage 308 of FIG. 3. At step 926 the processing device increments the counter m indicating that the processing device is performing steps relating to user m. For example, m is a set equal to 1 in a first iteration, indicating that the processing device is executing steps related to user 1 (e.g., a first user).

At step 928, the processing device reconciles and combines the temporary identification data for user m. For example, if temporary voice and facial recognition data were retrieved for user m, then the processing device compiles the temporary data and associates it with user m. The processing device then performs step 930 by accessing stored ID data from a database. In certain approaches, the database includes previously collected detection and identification data for a user. For example, the database may include ID data collected by control circuitry 304 during a configuration process using screen 700. In certain implementations, the database includes ID data for multiple users. In certain approaches, the processing device retrieves ID data from a database stored locally. For example, the processing device may retrieve ID data from a database stored in storage 308. Additionally or alternatively, the processing device may retrieve data from a database stored remotely, such as on a server. For example, the processing device may retrieve ID data from profiles database 626 stored on identification server 624 via communications network 614. At step 930, the processing device also compares the ID data retrieved from a database with the temporary ID data associated with user m to determine whether or not the user can be positively identified. The processing device may use pattern recognition algorithms to compare the data and identify a user. For example, the processing device may use classification, clustering, regression pattern recognition algorithms, Bayesian classifiers, kernel estimation, neural networks, principal component analysis, Markov models, Kalman filters, Gaussian regression algorithms, ensemble learning techniques, or any other appropriate recognition algorithms or techniques. In certain approaches, the processing device determines a probability estimate or confidence interval for the likelihood of user identification. For example, the processing device may determine that there is a 80% match or probability that the temporary ID data associated with user m is associated with a particular user from the database.

At step 932, the processing device determines whether user m has been identified. In certain approaches, the processing device may compare a probability of identification as determined at process step 930 with a specified minimum probability of identification. For example, if the specified minimum probability is at least 75% and the temporary ID data associated with user m has a probability of identification with a particular user of at least 75%, then the processing device classifies user m as identified as the user from the database. If the determined match probability is less than 75%, then the processing device classifies user m as unidentified. Any appropriate minimum probability or confidence interval may be used.

If the processing device identifies user m, then the processing device retrieves a profile associated with user m at step 940. In certain approaches, the user profile is stored locally. For example, the user profile may be stored in 308 of device 300. Additionally or alternatively, the user profile may be stored remotely. For example, the user profile may be stored in profile database 626 of identification server 624 and may be retrieved by the processing device via communications network 614. After retrieving the profile for user m, the processing device executes step 942 by adding user m to the temporary user list. After adding user m into the temporary user list, the processing device executes step 944 by assigning user m to a presentation device. A presentation device may be one of display 312, display 313, audio device 314, audio device 315, or any other device or system for presenting a media asset. In certain approaches, a presentation device may include a combination of devices. For example, a presentation device may include a display device and an audio device. In certain approaches, the processing device assigns user m to a presentation device according to the position of user m relative to a presentation device. For example, if the presentation device is part of a multi-view display (e.g., device 400), the processing device may assign user m to the presentation device which is viewable by user m based on the position of user m. The processing device then determines at step 946 whether all users have been identified by comparing the counter m to the quantity of detected users. If the counter m is less than the quantity of users, then the processing device executes step 926 by incrementing the counter m and proceeding with the identification steps as described. If the counter m is not less than the quantity of users, then the processing device proceeds to determine the active user list, as described below.

If the processing device is unable to identify user m at steps 930 and 932, the processing device proceeds to step 934 and requests permission settings from a master user. The processing device enables input from a master user to set media access permissions for the identified user. In certain approaches, the processing device displays a screen requesting input from a master user. For example, the processing device may provide screen 800 as described above or any other input means or screens to allow media access permissions to be set for user m. In certain approaches, the processing device automatically detects and identifies a master user. In certain approaches, the processing device requests a password from a master user. At step 936, the processing device determines whether permission setting were received from the master user. If permissions setting were received, the processing device executes step 942, as described above, by adding user m to the temporary user list and assigning user m to a presentation device. If media access permissions were not received, the processing device performs step 938 by setting default media access permissions for user m. For example, default media access permissions may be specified by a master user before accessing media or may be set using any of the methods described above for setting default media access permissions. The processing device then proceeds to execute steps 942 and 944, as described above, by adding user m to the temporary user list and assigning user m to a presentation device.

At step 946, the processing device compares the counter m with the quantity of users to determine whether all users have been added to the temporary user list. As described above, if the counter m is less than the quantity of users, then the processing device executes step 926 by incrementing the counter m and proceeding with the identification steps as described above. If the counter m is not less than the quantity of users, then the processing device proceeds to determine the active user list. To do so, the processing device executes step 948 by checking whether the counter h is equal to 0. A value of h equal to zero indicates that no users have been added to the active user list. Accordingly, the processing device performs step 950 to set the active user list by overwriting the active user list with the data from the temporary user list. After the processing device sets the active user list, the processing device performs step 956 to initialize media access permission alignment by setting a counter k equal to 0. The counter k is used to track the presentation devices for presenting media content. The counter k may be implemented by control circuitry 304 of FIG. 3 and may be stored in memory such as storage 308 of FIG. 3. At step 958, the processing device increments the counter k, indicating that the processing device is performing steps relating to presentation device k. For example, k is set equal to 1 in the first iteration, indicating that the subsequent steps are performed for presentation device 1 (e.g., a first presentation device).

As described above with reference to step 944, each identified user is assigned to a presentation device. In certain cases, a plurality of users may be assigned to a single presentation device. For example, when using a multi-view display (such as parallax display device 400 of FIG. 4), a plurality of users may be positioned to watch the same view of the display. At step 960, the processing device compares the media access permissions for all users at presentation device k and determines the lowest access permissions. If only one user is present at presentation device k, the access permissions for that user are used. If, however, a plurality of users are present at presentation device k, then the processing device compares the media access permissions of all users at presentation device k to determine if there are any conflicts and identify the common media access permissions. For example, if a first user has media access permissions that allow the first user to view movies rated PG-13 and below, while a second user at presentation device k has media access permissions to view movies rated PG and below, the processing device determines that the common media access permissions for the users at presentation device k would be for movies rated PG and below.

After determining the media access permissions, the processing device performs step 962 by retrieving the media asset. In certain approaches, the media asset is stored locally, for example, in storage 308 of FIG. 3. For example, the media asset may be stored on a disc or other removable storage media, such as a DVD. In certain approaches, the media asset is located in remote memory, such as on a server. For example, the media asset may be stored on media content server 616 and retrieved by the processing device via communications network 614. The media asset is described by and includes media asset attributes. For example, the media asset may have an attribute that identifies the rating of a movie. In certain approaches, the media asset attributes include subtitles to identify language used in the movie. In certain approaches, the media asset attributes include identifiers or bookmarks to identify objectionable scenes, images or audio. For example, media asset attributes may be included as metadata associated with the media asset, or may be in the form of data separate from the media asset. The media attributes may be retrieved by the processing device, for example, from media content source 616 or media guidance data source 418. At step 964, the processing device compares the media asset attributes with the common media access permissions of the users at device k as determined at step 960. If there is no conflict between the media asset attributes and the access permissions of the users, the processing device proceeds to execute step 968 and initiate transmission of the media asset to presentation device k. If the processing device determines that there is a conflict between the media asset attributes and the common media access permissions of users at device k, the processing device executes step 970 by initiating transmission of an access-aligned media asset to presentation device k. As described previously, an access-aligned media asset may be an edited version of media asset that satisfies or substantially satisfies the media access permissions. In certain approaches, the access-aligned media asset may be an alternative media asset.

After initiating transmission of a media asset at step 970 or step 968, the processing device compares the value of counter k to the quantity of presentation devices to determine whether transmission of a media asset has been initiated at all presentation devices. If the counter k is less than the quantity of presentation devices, the processing device executes step 958 to increment the counter k and proceeds to determine media access permissions for users at each device and initiate transmission of a media asset to each device by performing steps 958, 960, 964, 966, 968, and/or 970 as described above. If, at process step 972, the counter k is not less than the quantity of presentation devices, then transmission of a media asset has been initiated at each presentation device. Accordingly, the processing device proceeds from step 972 to execute step 954 by incrementing the counter h to repeat the detection and identification steps described above.

The processing device continually detects and identifies users to ensure that the media content being presented meets the media access permissions of all users present. The processing device thereby maintains an accurate active user list, even when users enter or leave the vicinity of the presentation device or devices. When performing the detection and identification steps, the processing device executes step 948 to determine whether the counter h is equal to zero. In iterations beyond the first iteration, h is not equal to zero. Accordingly, the processing device determines, at step 952, whether there are differences between the temporary user list and active user list by comparing the two lists. If there are no differences between the temporary user list and the active user list, the processing device continues to cycle through the detection and identification steps described above by proceeding to step 954, incrementing h, and initializing a temporary user list. If new users have approached the media device, or if some users have left the vicinity of the user device, the processing device determines, at step 952, that there is a difference between the temporary user list and the active user list. Accordingly, the processing device overwrites the active user list with the temporary user list at step 950. The processing device then proceeds to step 956 to perform the access alignment steps as described herein for aligning the permissions of the users at the presentation devices with appropriate media assets and transmitting those assets.

It should be understood that the above steps of the flow diagram of FIG. 9 may be executed or performed in any order and are not limited to the illustrated order. Some of the above steps of the flow diagram of FIG. 9 may be executed or performed substantially simultaneously where appropriate, or in parallel, to reduce latency and processing times. In certain approaches, various steps described above may be combined, omitted, not implemented, or integrated in other systems.

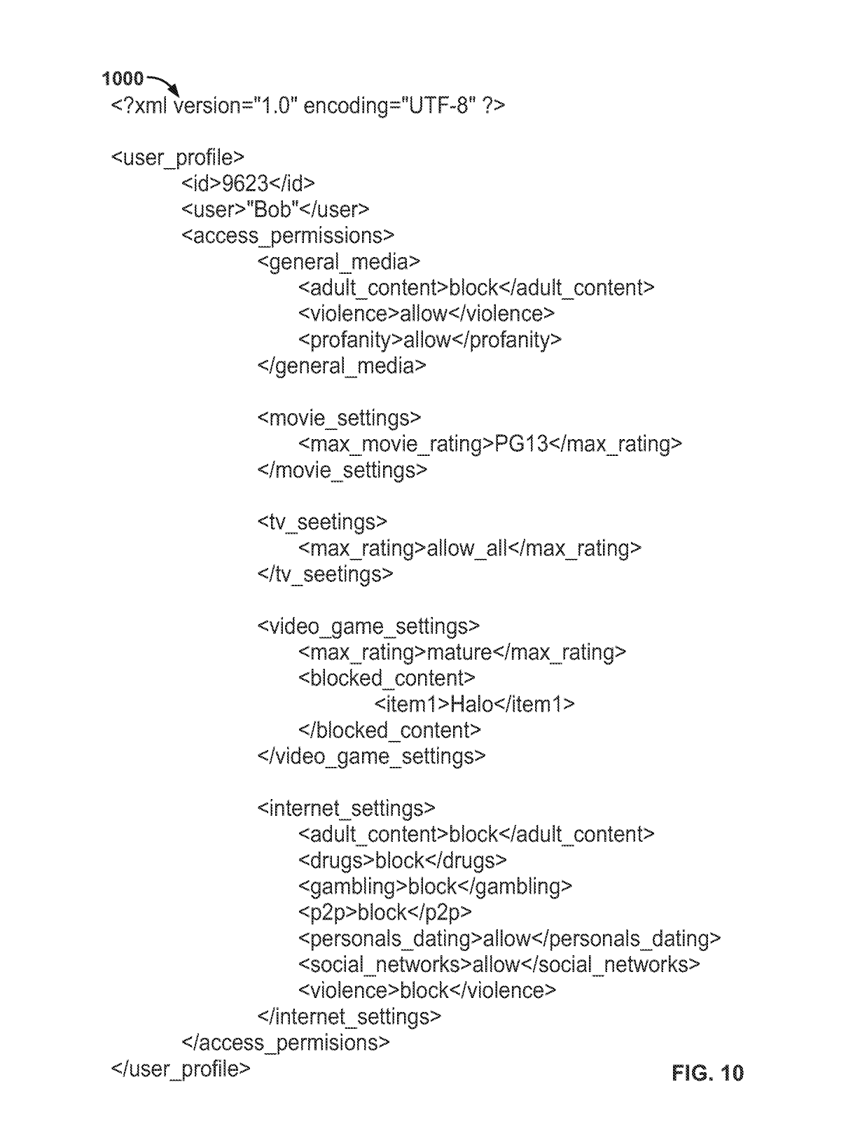

FIG. 10 shows an illustrative example of a user profile stored as file 1000 in Extensible Markup Language (XML) in accordance with some implementations. File 1000 may be stored, for example, in storage 308 of FIG. 3, user equipment 602, 604, or 606, or profile database 626 of FIG. 6. While shown as XML, file 1000 may alternatively be in another suitable markup language (e.g., HTML5) or file format (e.g., Flash). File 1000 may be produced, for example, in response to user inputs provided in response to screen 800 of FIG. 8. File 1000 may be retrieved when requested, for example, by control circuitry 304 of FIG. 3.

File 1000, as shown, may include tags and data specifying identification information (an ID number, a user entry) and access permissions, including permission for various media types (general, movies and video, television, video games, Internet, etc.). The ID number may be used internally by device 300 to identify and/or track the user profile. In certain approaches, the ID number is used to identify a user within a database, such as profile database 626. File 1000 may include access settings for ratings of media content. File 1000 may include restrictions on access to adult content, violence, profanity, drug content, gambling, peer-to-peer applications, personals or dating content, and social networks. In certain approaches, the access restrictions may broadly block or allow the content. In certain approaches, the access restrictions include various scales or ratings to adjust levels of restrictions on content. For example, violence or profanity may be rated on a scale of 1-10. In certain approaches, file 1000 includes permissions for specific media assets, such as specific shows, video games, songs, or websites. In certain approaches, file 1000 does not include all of the illustrated entries, or may include additional entries. These entries may be automatically determined, accessed, modified, added, and updated during the configuration process.

It should be noted, that a device may perform any suitable number of the actions described above with regard to media access permissions and controls. Additionally, the actions performed may be automatic and/or the device may provide options to active the actions in any suitable fashion. The aforementioned and/or any other media access permissions and controls may be activated in response to any suitable user detection. For example, the controls may be activated whether or not a conflicted user is authorized on the device, whether or not a conflicted user is within the device's detection region, or in any other suitable manner. For example, the controls may be activated in response to detecting a user regardless of whether the user has been identified and/or authorized.

The guidance and parental control applications described herein may be implemented using any suitable architecture. For example, a guidance application may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

It will be apparent to those of ordinary skill in the art that methods, techniques, and processes involved in the present disclosure may be embodied in a computer program product that includes a non-transitory computer usable and/or readable medium. For example, such a non-transitory computer readable medium may consist of a read-only memory device, such as a CD-ROM disk or conventional ROM devices, or a random access memory, such as a hard drive device or a computer diskette, having a computer readable program code stored thereon.

It is to be understood that while certain forms of the present disclosure have been illustrated and described herein, it is not to be limited to the specific forms or arrangement of parts described and shown. Those skilled in the art will know or be able to ascertain using no more than routine experimentation, many equivalents to the embodiments and practices described herein. Accordingly, it will be understood that the invention is not to be limited to the embodiments disclosed herein, which are presented for purposes of illustration and not of limitation.

1. A computer-implemented method for providing media content to a plurality of users, the method comprising:
delivering a media asset to a first user using a first view of a multi-view electronic media device;
receiving a signal, from a user identification device, indicative of a second user associated with a second view of the multi-view electronic media device;
accessing, from a memory, a profile associated with the second user indicated by the received signal, wherein the second user profile includes a media access permission for the second user;
identifying the media asset being delivered to the first user;
receiving a signal representative of an attribute of the identified asset;
comparing the attribute of the identified asset with the media access permission of the second user; and
delivering an access-aligned version of the identified asset to the second user using the second view of the multi-view electronic media device while delivering the media asset to the first user using the first view of the multi-view electronic media device, wherein the access-aligned version of the media asset satisfies the media access permission of the second user profile and differs from the media asset in at least one of visual content and audio content.

2. The method of claim 1, wherein the first view and the second view are integral to the multi-view electronic media device.

3. The method of claim 1, further comprising:
prior to delivering the media asset to the first user:
receiving a signal, from the user identification device, indicative of the first user associated with the first view of the multi-view electronic media device;
accessing, from the memory, a profile associated with the first user, wherein the first user profile includes a media access permission for the first user; and
wherein the media asset delivered to the first user at the first view of the multi-view electronic media device satisfies the media access permissions of the first user profile.

4. The method of claim 1, wherein the signal indicative of the second user is generated by the user identification device based on at least one of a biometric identification technique, an image of the second user, and a position of the second user.

5. The method of claim 1, wherein the signal indicative of the second user is generated by the user identification device based on a radio frequency signal from a radio frequency beacon associated with the second user.

6. The method of claim 1, wherein the signal indicative of the second user is generated by the user identification device based on accessing an electronic personal identification device associated with the second user, wherein the electronic personal identification device includes the memory storing the profile associated with the second user.

7. The method of claim 6, wherein the signal indicative of the second user is generated by the user identification device based on receiving a connector of the electronic personal identification device in a receptacle of the multi-view electronic media device.

8. The method of claim 7, wherein the personal identification device is a personal listening device.

9. The method of claim 1, wherein the second media asset is a modified version of the first media asset.

10. The method of claim 9, wherein the first view comprises a first display and the second view comprises a second display different from the first display, and wherein the first media asset has a first image content delivered on the first display and the second media asset has a second image content different from the first image content delivered on the second display.

11. The method of claim 9, wherein the first view comprises a first audio output and the second view comprises a second audio output different from the first audio output, and wherein the first media asset has a first audio content delivered to the first user via the first audio output and the second media asset has a second audio content different from the first audio content delivered to the second user via the second audio output.

12. The method of claim 1, wherein accessing the profile associated with the second user comprises accessing a remote server.

13. A system for providing media content to a plurality of users, the system comprising:
a processor configured to:
deliver a media asset to a first user using a first view of a multi-view electronic media device;
receive a signal, from a user identification device, indicative of a second user associated with a second view of the multi-view electronic media device;
access, from a memory, a profile associated with the second user indicated by the received signal, wherein the second user profile includes a media access permission for the second user;
identify the media asset being delivered to the first user;
receive a signal representative of an attribute of the identified asset;
compare the attribute of the identified asset with the media access permission of the second user; and
deliver an access-aligned version of the identified asset to the second user using the second view of the multi-view electronic media device while delivering the media asset to the first user using the first view of the multi-view electronic media device, wherein the access-aligned version of the media asset satisfies the media access permission of the second user profile and differs from the media asset in at least one of visual content and audio content.

14. The system of claim 13, wherein the first view and second view are integral to the multi-view electronic media device.

15. The system of claim 13, wherein the processor is configured to:
receive a signal, from the user identification device, indicative of the first user associated with the first view of the multi-view electronic media device prior to delivering the media asset to the first user;
access, from the memory, a profile associated with the first user, wherein the first user profile includes a media access permission for the first user; and
wherein the media asset delivered to the first user at the first view of the multi-view electronic media device satisfies the media access permissions of the first user profile.

16. The system of claim 13, wherein the signal indicative of the second user is generated by the user identification device based on at least one of a biometric identification technique, an image of the second user, and a position of the second user.

17. The system of claim 13, wherein the signal indicative of the second user is generated by the user identification device based on a radio frequency signal from a radio frequency beacon associated with the second user.

18. The system of claim 13, wherein the signal indicative of the second user is generated by the user identification device based on accessing an electronic personal identification device associated with the second user, wherein the electronic personal identification device includes the memory storing the profile associated with the second user.

19. The system of claim 18, wherein the signal indicative of the second user is generated by the user identification device based on receiving a connector of the electronic personal identification device in a receptacle of the multi-view electronic media device.

20. The system of claim 19, wherein the personal identification device is a personal listening device.

21. The system of claim 13, wherein the second media asset is a modified version of the first media asset.

22. The system of claim 21, wherein the first view comprises a first display and the second view comprises a second display different from the first display, and wherein the first media asset has a first image content delivered on the first display and the second media asset has a second image content different from the first image content delivered on the second display.

23. The system of claim 21, wherein the first view comprises a first audio output and the second view comprises a second audio output different from the first audio output, and wherein the first media asset has a first audio content delivered to the first user via the first audio output and the second media asset has a second audio content different from the first audio content delivered to the second user via the second audio output.

24. The system of claim 13, wherein the processor is configured to access the profile associated with the second user by accessing a remote server.

25-36. (canceled)
